(19) United States
(12) Patent Application Publication
(10) Pub. No.: US 2026/0233836 A1
(43) Pub. Date: Aug. 13, 2026

(54) Reweigh Maneuver for Accurate Payload Mass Estimation

(71) Applicant: Wing Aviation LLC, Palo Alto, CA (US)

(72) Inventors: Anna Verkhovskaya, San Mateo, CA (US); Marcus Hammond, Redwood City, CA (US); Ivan Qiu, Redwood City, CA (US)

(21) Appl. No.: 19/173,024

(22) Filed: Apr. 8, 2025

Related U.S. Application Data
(60) Provisional application No. 63/755,581, filed on Feb. 7, 2025.

(51) Int. Cl. B64D 1/22; B64U 101/67; B66C 13/06; B66C 13/16

(52) U.S. Cl. CPC B64D 1/22; B66C 13/063; B66C 13/16; B64U 2101/67

(57) ABSTRACT

A method includes causing an aerial vehicle to retract, to within a first distance of the aerial vehicle, a payload that is coupled to the aerial vehicle by a tether. The method also includes causing the aerial vehicle to lower the payload from the aerial vehicle by at least a second distance. The method additionally includes obtaining data indicative of a force applied to the tether by the payload while the payload is lowered from the aerial vehicle, and determining a mass of the payload based on the data indicative of the force applied to the tether by the payload. The method further includes determining, based on the mass of the payload, a maneuver to be performed with the payload by the aerial vehicle, and causing the aerial vehicle to perform the maneuver.

### CROSS-REFERENCE TO RELATED APPLICATIONS

The present application claims priority to U.S. Provisional Patent Application No. 63/755,581, filed Feb. 7, 2025, the contents of which are hereby incorporated by reference in its entirety.

### BACKGROUND

Aerial vehicles may be configured to transport payloads. The payloads and/or the aerial vehicles may be subject to maximum mass limits that define a maximum mass of each payload and/or a maximum combined mass of the aerial vehicle plus its payload. Accordingly, it may be desirable to quickly and/or accurately determine the mass of a payload picked up by an aerial vehicle to prior to initiating transport of the payload.

### SUMMARY

An aerial vehicle may be configured to perform one or more maneuvers to assist with determining a mass of a payload picked up by the aerial vehicle. Specifically, after picking up the payload using a tether, the aerial vehicle may be configured to bring the payload closer to the aerial vehicle by retracting the tether. For example, the payload may be retracted to within a first distance of the aerial vehicle, thereby stabilizing the payload relative to the aerial vehicle and reducing or eliminating stray forces on the payload due to, for example, wind, friction, and/or oscillations. The payload may then be lowered from the aerial vehicle (e.g., at constant velocity) over at least a second distance to allow the payload to exert on the tether a force that is substantially equal to the weight of the payload. As the payload is lowered, the aerial vehicle may be configured to obtain data indicative of a force applied to the tether by the payload, and this data may be used (e.g., in combination with the acceleration due to gravity) to determine the mass of the payload. Depending on the mass of the payload, the aerial vehicle may be configured to transport the payload to its destination or drop off the payload at or near the location from which the payload was picked up, among other possibilities.

In a first example embodiment, an aerial vehicle may be caused to retract, to within a first distance of the aerial vehicle, a payload that is coupled to the aerial vehicle by a tether. The aerial vehicle may also be caused to lower the payload from the aerial vehicle by at least a second distance. The first example embodiment also includes obtaining data indicative of a force applied to the tether by the payload while the payload is lowered from the aerial vehicle, and determining a mass of the payload based on the data indicative of the force applied to the tether by the payload. The first example embodiment further includes determining, based on the mass of the payload, a maneuver to be performed with the payload by the aerial vehicle, and causing the aerial vehicle to perform the maneuver.

In a second example embodiment, a system may include a processor and a non-transitory computer-readable medium having stored thereon instructions that, when executed by the processor, cause the processor to perform operations in accordance with the first example embodiment.

In a third example embodiment, a system may include a processor configured to perform operations in accordance with the first example embodiment.

In a fourth example embodiment, a non-transitory computer-readable medium may have stored thereon instructions that, when executed by a computing device, cause the computing device to perform operations in accordance with the first example embodiment.

In a fifth example embodiment, a system may include various means for carrying out each of the operations of the first example embodiment.

In a sixth example embodiment, a computer program product may include instructions for carrying out operations in accordance with the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1A illustrates an uncrewed aerial vehicle, in accordance with examples described herein.

FIG. 1B illustrates an uncrewed aerial vehicle, in accordance with examples described herein.

FIG. 1C illustrates an uncrewed aerial vehicle, in accordance with examples described herein.

FIG. 1D illustrates an uncrewed aerial vehicle, in accordance with examples described herein.

FIG. 1E illustrates an uncrewed aerial vehicle, in accordance with examples described herein.

FIG. 2 illustrates components of an uncrewed aerial system, in accordance with examples described herein.

FIG. 3 is a block diagram illustrating a distributed UAV system, in accordance with examples described herein.

FIGS. 4A, 4B, 4C, and 4D illustrate maneuvers involved in determining a mass of a payload, in accordance with examples described herein.

FIG. 5 illustrates graphs of force over time and deployed tether length over time, in accordance with examples described herein.

FIG. 6 illustrates a payload mass model, in accordance with examples described herein.

FIG. 7 illustrates a flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. Overview

An aerial vehicle, such as an uncrewed aerial vehicle (UAV), may be configured to transport a payload having a mass that is less than a maximum mass threshold. The maximum mass threshold may be determined based on and/or may correspond to physical capabilities of the aerial vehicle (e.g., flight range under particular environmental conditions), a distance over which the payload is to be transported, and/or regulations imposed on operations of the aerial vehicle, among other factors. Accordingly, it may be important and/or desirable to quickly, easily, and/or accurately determine the mass of the payload before transporting the payload by the aerial vehicle to the payload's destination. In particular, it may be desirable for the aerial vehicle to autonomously determine the mass of the payload without human involvement.

Accordingly, the aerial vehicle may be configured to perform a payload weighing maneuver that allows for and/or facilitates an accurate determination of the mass of the payload. Specifically, the aerial vehicle may pick up the payload by connecting a payload coupling apparatus to the payload. The payload coupling apparatus may be connected to the aerial vehicle by way of a tether, which may be extendable from and/or retractable to the aerial vehicle using a winch system. Specifically, the winch system may include a motor configured to rotate a spool around which the tether is wound, and the motor may be used to control a length of tether deployed from the aerial vehicle.

Once the payload coupling apparatus is connected to the payload, the aerial vehicle may retract the payload to within a first distance (e.g., a first predetermined threshold distance) of the aerial vehicle by reeling in the tether. For example, retracting the payload may incrementally bring the payload closer to the aerial vehicle until at least a portion/part of the payload comes into contact with at least a portion/part of a body of the aerial vehicle. In some cases, bringing the payload within the first distance of the aerial vehicle may position and/or prepare the payload for transport (although transport of the payload might not start until after the payload is weighed).

Bringing the payload within the first distance of the aerial vehicle may also stabilize the payload relative to the aerial vehicle to thereby reduce stray forces on the payload due to wind, friction, and/or oscillations of the payload. For example, once the payload is within the first distance of the aerial vehicle, the payload may exhibit little to no swaying, swinging, and/or oscillation relative to the aerial vehicle due to being in close proximity therewith (e.g., due to being held in a fixed position relative to the aerial vehicle). As a result, stray forces due to the swaying, swinging, and/or oscillation may be reduced, minimized, and/or eliminated. The aerial vehicle may then lower the payload from the aerial vehicle by at least a second distance (e.g., 25 centimeters, 30 centimeters, 35 centimeters, etc.) by unspooling the tether. The payload may be lowered from the aerial vehicle at a substantially constant velocity (e.g., 0.15 meters per second, 0.2 meters per second, 0.25 meters per second, etc.), which may be predetermined.

Additionally, the velocity at which the payload is lowered may be selected to reduce and/or minimize an amount of frictional force(s) experienced due to, for example, gearbox components, the tether rubbing and/or sliding against other components, and/or packing of the tether on the spool, among others. In some cases, as the payload is lowered, the aerial vehicle may attempt to hover in a substantially fixed position in space (e.g., both vertically and horizontally), and may thus provide a substantially fixed reference point relative to which the payload is lowered. As a result, when the payload is lowered over the second distance, a force exerted on the tether may represent substantially, primarily, and/or exclusively a weight of the payload, with little to no noise from the stray forces.

While the payload is lowered over the second distance, the aerial vehicle may collect data that is indicative of a force applied to the tether by the payload, and this data may be used to determine the mass of the payload. As one example, the aerial vehicle may determine an electrical current value associated with operation of the motor while lowering the payload over the second distance (e.g., an electrical current commanded to the motor and/or an electrical current actually drawn by the motor). The electrical current value may be used to determine a torque applied to the spool, the torque applied to the spool may be used in combination with a radius of the spool to determine a weight of the payload, and this weight may be divided by the acceleration due to gravity to determine the mass of the payload. As another example, the aerial vehicle may collect sensor data from a load cell that couples the tether to the payload coupling apparatus and thus indicates the force applied to the tether by the payload coupling apparatus and any payloads connected thereto. The force indicated by the load cell may be divided by the acceleration due to gravity to determine the mass of the payload. Other sensors, measurement mechanisms (both direct and indirect), and/or combinations thereof may be used to determine the mass of the payload.

In some cases, the second distance over which the payload is lowered may be selected so as to allow the aerial vehicle to collect at least a threshold number of data points indicative of the force (e.g., at least 10 samples). Thus, the data indicative of the force applied to the tether by the payload as the payload is lowered may include a plurality of data points corresponding to time points during the payload being lowered from the aerial vehicle over the second distance. The plurality of data points may be filtered (e.g., averaged, median filtered, low-pass filtered, etc.) and/or otherwise combined to determine a filtered value that represents the force applied to the tether by the payload as it is lowered from the aerial vehicle over the second distance.

In some implementations, the weight and/or mass of the payload may be determined using a regression model. The regression model may include linear terms and/or nonlinear terms. The regression model may include physics-based equations and/or parameters determined through training. For example, the regression model may include a machine learning model (e.g., artificial neural network (ANN)), a linear regression model, and/or a polynomial regression model, among other possibilities. The regression model may be configured to determine the weight and/or mass of the payload based on one or more inputs that describe performance of various components of the aerial vehicle and/or operating conditions of the aerial vehicle while the payload is lowered over the second distance.

For example, the inputs may include an electrical current value associated with operation of the motor, an angular velocity value associated with operation of the motor, an angular position value associated with operation of the motor, flight control data from the aerial vehicle, and/or an environmental condition value that represents an environmental condition (e.g., wind, temperature, pressure, etc.) present in an environment of the aerial vehicle. The inputs to the regression model may include values collected while the payload is lowered from the aerial vehicle over the second distance, values collected while the empty tether is deployed from the aerial vehicle prior to pick-up of the payload, and/or values collected while the payload is retracted towards the aerial vehicle after pick-up of the payload. Values collected prior to pick-up of the payload may provide a baseline relative to which the values collected while the payload is retracted and/or lowered may be compared and/or more accurately measured.

In some cases, the payload weighing maneuver as described above may be performed based on, in combination with, and/or in response to determining an initial estimate of the mass of the payload based on data collected as the payload is retracted towards the aerial vehicle. Specifically, after the payload is picked up by the aerial vehicle (e.g., from a ground surface and/or from a payload loading apparatus) and while it is retracted towards the aerial vehicle, the aerial vehicle may be configured to obtain initial data that is indicative of initial force(s) applied to the tether by the payload. The initial data may be used to determine the initial estimate of the mass of the payload in the same or similar manner as described above (e.g., using motor current data, load cell data, etc.). The initial estimate of the mass may be less accurate than the determination of the mass using the payload weighing maneuver, at least due to greater stray forces present during winch-up of the payload than during winch-down of the payload.

If the initial estimate of the mass does not exceed an initial mass threshold for the payload, the payload weighting maneuver may be avoided. Specifically, the initial mass threshold for the payload may be lower than the maximum mass threshold, thus allowing for inaccuracies in the initial estimate of the mass due to stray forces present while the payload is being retracted towards the aerial vehicle. For example, the initial mass threshold may include a sufficient safety factor relative to the maximum mass threshold such that payloads that are lighter than the maximum mass threshold are not expected to exceed the initial mass threshold under worst-case environmental conditions (e.g., large payload oscillations due to high wind) and/or aircraft states (e.g., large amounts of friction in winch components).

If the initial estimate of the mass exceeds the initial mass threshold for the payload, the payload weighting maneuver may be performed based on and/or in response to the initial estimate of the mass exceeding the initial mass threshold. Thus, payloads that are likely, based on the initial mass estimate, to exceed the maximum mass threshold may be reweighed using the payload weighting maneuver. Thus, the payload weighting maneuver may, in some cases, be referred to as a payload reweighing maneuver since it occurs after, based on, and/or in response to the determination of the initial estimate of the mass of the payload.

### II. Example Uncrewed Vehicles

Herein, the terms “unmanned aerial system,” “uncrewed aerial system,” and/or “UAV” refer to any autonomous or semi-autonomous vehicle that is capable of performing some functions without a physically present human pilot. A UAV can take various forms. For example, a UAV may take the form of a fixed-wing aircraft, a glider aircraft, a tail-sitter aircraft, a jet aircraft, a ducted fan aircraft, a lighter-than-air dirigible such as a blimp or steerable balloon, a rotorcraft such as a helicopter or multicopter, and/or an ornithopter, among other possibilities. Further, the terms “drone,” “uncrewed aerial vehicle system” (UAVS), “unmanned aerial vehicle,” or “uncrewed aerial vehicle” may also be used to refer to a UAV.

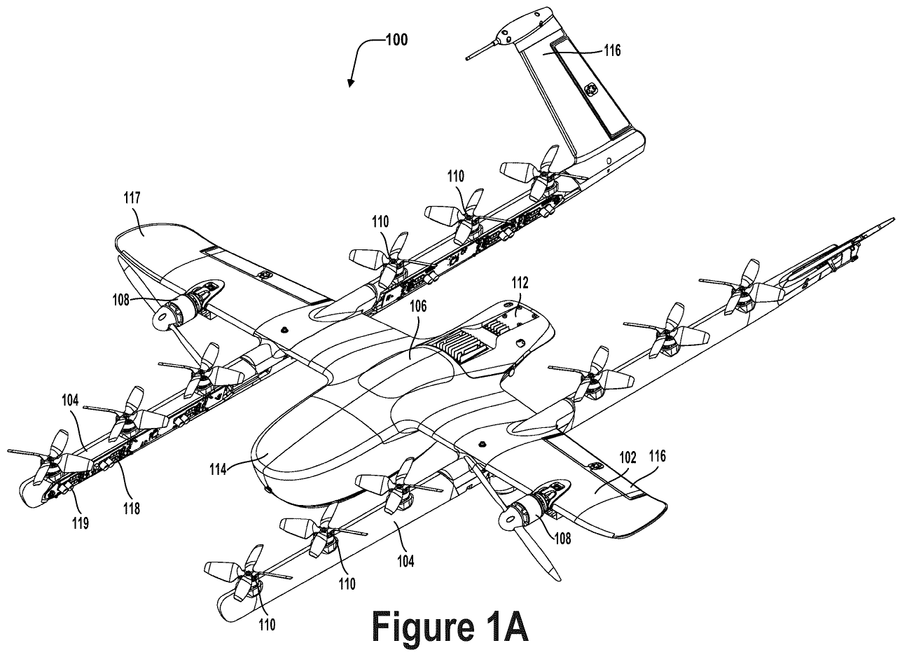

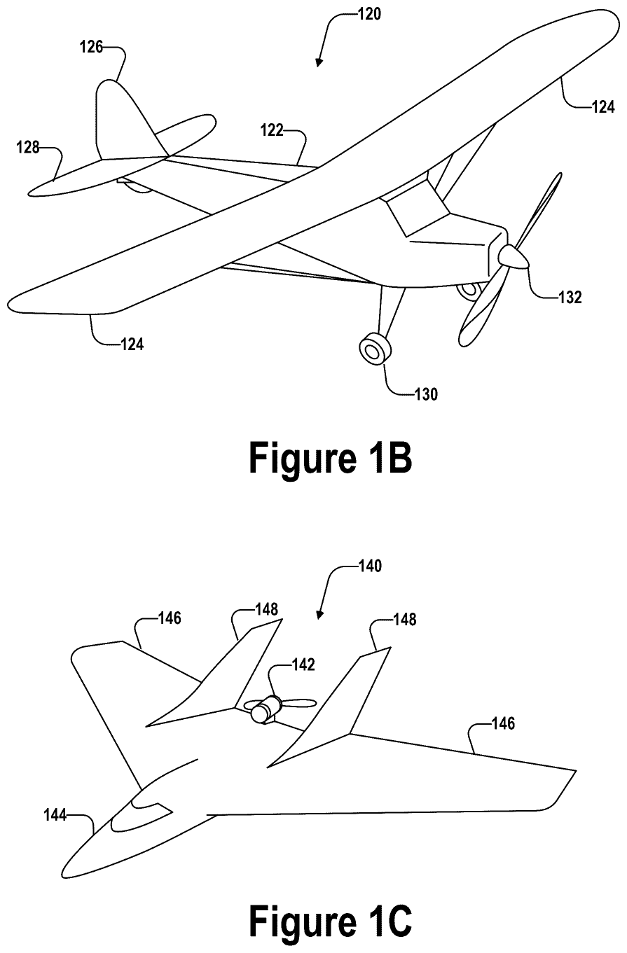

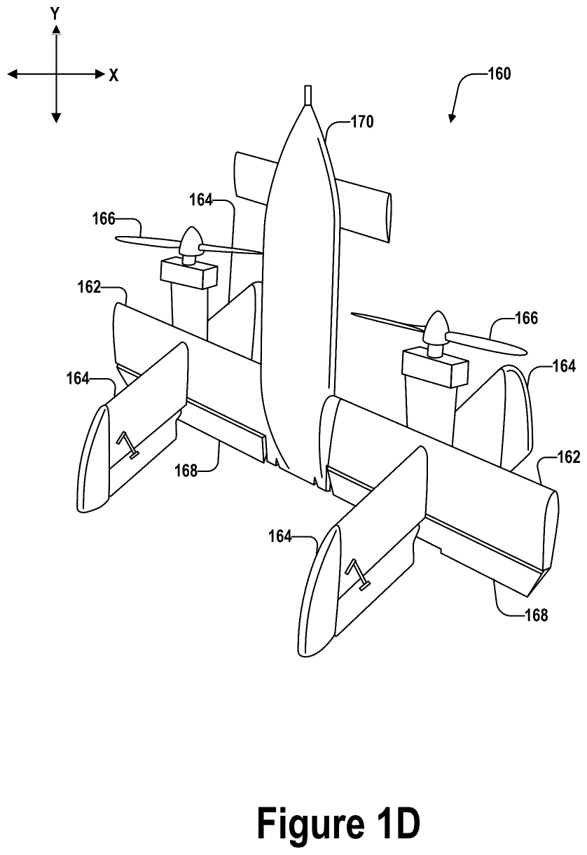

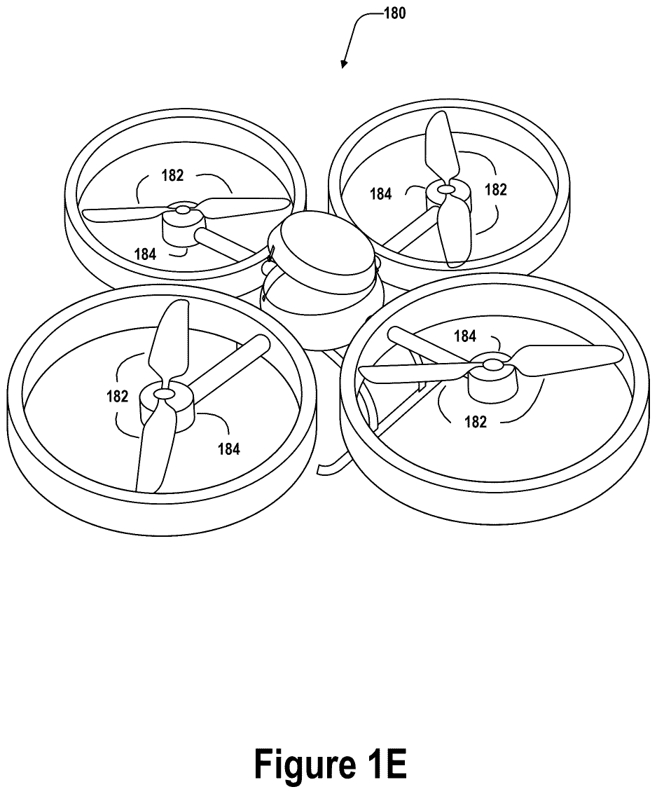

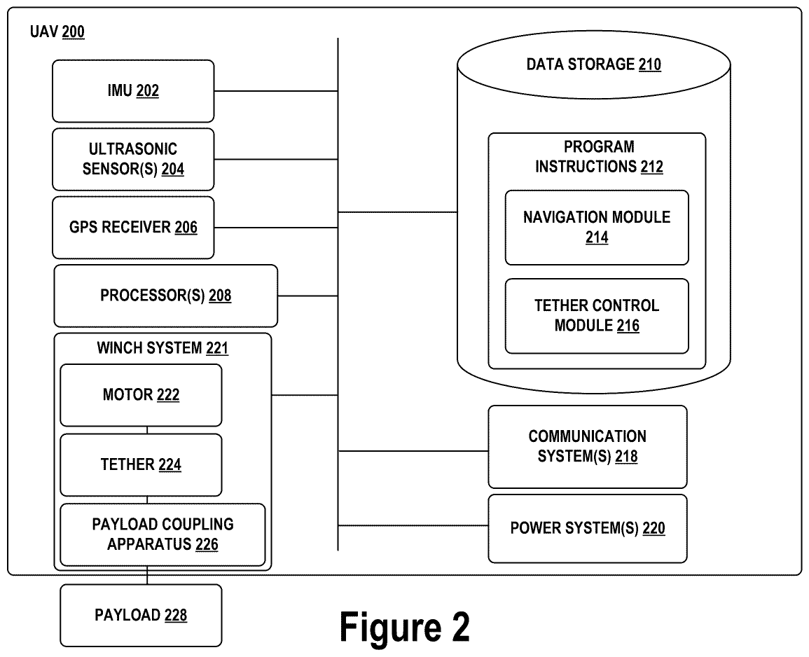

FIG. 1A is an isometric view of an example UAV 100. UAV 100 includes wing 102, booms 104, and a fuselage 106. Wings 102 may be stationary and may generate lift based on the wing shape and the UAV's forward airspeed. For instance, the two wings 102 may have an airfoil-shaped cross section to produce an aerodynamic force on UAV 100. In some embodiments, wing 102 may carry horizontal propulsion units 108, and booms 104 may carry vertical propulsion units 110. In operation, power for the propulsion units may be provided from a battery compartment 112 of fuselage 106. In some embodiments, fuselage 106 also includes an avionics compartment 114, an additional battery compartment (not shown) and/or a delivery unit (not shown, e.g., a winch system) for handling the payload. In some embodiments, fuselage 106 is modular, and two or more compartments (e.g., battery compartment 112, avionics compartment 114, other payload and delivery compartments) are detachable from each other and securable to each other (e.g., mechanically, magnetically, or otherwise) to contiguously form at least a portion of fuselage 106.

In some embodiments, booms 104 terminate in rudders 116 for improved yaw control of UAV 100. Further, wings 102 may terminate in wing tips 117 for improved control of lift of the UAV.

In the illustrated configuration, UAV 100 includes a structural frame. The structural frame may be referred to as a “structural H-frame” or an “H-frame” (not shown) of the UAV. The H-frame may include, within wings 102, a wing spar (not shown) and, within booms 104, boom carriers (not shown). In some embodiments the wing spar and the boom carriers may be made of carbon fiber, hard plastic, aluminum, light metal alloys, or other materials. The wing spar and the boom carriers may be connected with clamps. The wing spar may include pre-drilled holes for horizontal propulsion units 108, and the boom carriers may include pre-drilled holes for vertical propulsion units 110.

In some embodiments, fuselage 106 may be removably attached to the H-frame (e.g., attached to the wing spar by clamps, configured with grooves, protrusions or other features to mate with corresponding H-frame features, etc.). In other embodiments, fuselage 106 similarly may be removably attached to wings 102. The removable attachment of fuselage 106 may improve quality and or modularity of UAV 100. For example, electrical/mechanical components and/or subsystems of fuselage 106 may be tested separately from, and before being attached to, the H-frame. Similarly, printed circuit boards (PCBs) 118 may be tested separately from, and before being attached to, the boom carriers, therefore eliminating defective parts/subassemblies prior to completing the UAV. For example, components of fuselage 106 (e.g., avionics, battery unit, delivery units, an additional battery compartment, etc.) may be electrically tested before fuselage 106 is mounted to the H-frame. Furthermore, the motors and the electronics of PCBs 118 may also be electrically tested before the final assembly. Generally, the identification of the defective parts and subassemblies early in the assembly process lowers the overall cost and lead time of the UAV. Furthermore, different types/models of fuselage 106 may be attached to the H-frame, therefore improving the modularity of the design. Such modularity allows these various parts of UAV 100 to be upgraded without a substantial overhaul to the manufacturing process.

In some embodiments, a wing shell and boom shells may be attached to the H-frame by adhesive elements (e.g., adhesive tape, double-sided adhesive tape, glue, etc.). Therefore, multiple shells may be attached to the H-frame instead of having a monolithic body sprayed onto the H-frame. In some embodiments, the presence of the multiple shells reduces the stresses induced by the coefficient of thermal expansion of the structural frame of the UAV. As a result, the UAV may have better dimensional accuracy and/or improved reliability.

Moreover, in at least some embodiments, the same H-frame may be used with the wing shell and/or boom shells having different size and/or design, therefore improving the modularity and versatility of the UAV designs. The wing shell and/or the boom shells may be made of relatively light polymers (e.g., closed cell foam) covered by the harder, but relatively thin, plastic skins.

The power and/or control signals from fuselage 106 may be routed to PCBs 118 through cables running through fuselage 106, wings 102, and booms 104. In the illustrated embodiment, UAV 100 has four PCBs, but other numbers of PCBs are also possible. For example, UAV 100 may include two PCBs, one per the boom. The PCBs carry electronic components 119 including, for example, power converters, controllers, memory, passive components, etc. In operation, propulsion units 108 and 110 of UAV 100 are electrically connected to the PCBs.

Many variations on the illustrated UAV are possible. For instance, fixed-wing UAVs may include more or fewer rotor units (vertical or horizontal), and/or may utilize a ducted fan or multiple ducted fans for propulsion. Further, UAVs with more wings (e.g., an “x-wing” configuration with four wings), are also possible. Although FIG. 1 illustrates two wings 102, two booms 104, two horizontal propulsion units 108, and six vertical propulsion units 110 per boom 104, it should be appreciated that other variants of UAV 100 may be implemented with more or less of these components. For example, UAV 100 may include four wings 102, four booms 104, and more or less propulsion units (horizontal or vertical).

Similarly, FIG. 1B shows another example of a fixed-wing UAV 120. Fixed-wing UAV 120 includes fuselage 122, two wings 124 with an airfoil-shaped cross section to provide lift for UAV 120, vertical stabilizer 126 (or fin) to stabilize the plane's yaw (turn left or right), horizontal stabilizer 128 (also referred to as an elevator or tailplane) to stabilize pitch (tilt up or down), landing gear 130, and propulsion unit 132, which can include a motor, shaft, and propeller.

FIG. 1C shows an example of UAV 140 with a propeller in a pusher configuration. The term “pusher” refers to the fact that propulsion unit 142 is mounted at the back of UAV 140 and “pushes” the vehicle forward, in contrast to the propulsion unit 142 being mounted at the front of UAV 140. Similar to the description provided for FIGS. 1A and 1B, FIG. 1C depicts common structures used in a pusher plane, including fuselage 144, two wings 146, vertical stabilizers 148, and propulsion unit 142, which can include a motor, shaft, and propeller.

FIG. 1D shows an example tail-sitter UAV 160. In the illustrated example, tail-sitter UAV 160 has fixed wings 162 to provide lift and allow UAV 160 to glide horizontally (e.g., along the x-axis, in a position that is approximately perpendicular to the position shown in FIG. 1D). However, fixed wings 162 also allow tail-sitter UAV 160 to take off and land vertically on its own.

For example, at a launch site, tail-sitter UAV 160 may be positioned vertically (as shown) with fins 164 and/or wings 162 resting on the ground and stabilizing UAV 160 in the vertical position. Tail-sitter UAV 160 may then take off by operating propellers 166 to generate an upward thrust (e.g., a thrust that is generally along the y-axis). Once at a suitable altitude, tail-sitter UAV 160 may use flaps 168 to reorient itself in a horizontal position, such that fuselage 170 is closer to being aligned with the x-axis than the y-axis. Positioned horizontally, propellers 166 may provide forward thrust so that tail-sitter UAV 160 can fly in a similar manner as a typical airplane.

Many variations on the illustrated fixed-wing UAVs are possible. For instance, fixed-wing UAVs may include more or fewer propellers, and/or may utilize a ducted fan or multiple ducted fans for propulsion. Further, UAVs with more wings (e.g., an “x-wing” configuration with four wings), with fewer wings, or even with no wings, are also possible.

As noted above, some embodiments may involve other types of UAVs, in addition to or in the alternative to fixed-wing UAVs. For instance, FIG. 1E shows an example of rotorcraft 180 that is commonly referred to as a multicopter. Multicopter 180 may also be referred to as a quadcopter, as it includes four rotors 182. It should be understood that example embodiments may involve a rotorcraft with more or fewer rotors than multicopter 180. For example, a helicopter typically has two rotors. Other examples with three or more rotors are possible as well. Herein, the term “multicopter” refers to any rotorcraft having more than two rotors, and the term “helicopter” refers to rotorcraft having two rotors.

Referring to multicopter 180 in greater detail, four rotors 182 provide propulsion and maneuverability for multicopter 180. More specifically, each rotor 182 includes blades that are attached to motor 184. Configured as such, rotors 182 may allow multicopter 180 to take off and land vertically, to maneuver in any direction, and/or to hover. Further, the pitch of the blades may be adjusted as a group and/or differentially, and may allow multicopter 180 to control its pitch, roll, yaw, and/or altitude.

It should be understood that references herein to an “uncrewed” aerial vehicle or UAV can apply equally to autonomous and semi-autonomous aerial vehicles. In an autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator could control high level navigation decisions for a UAV, such as by specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

More generally, it should be understood that the example UAVs described herein are not intended to be limiting. Example embodiments may relate to, be implemented within, or take the form of any type of uncrewed aerial vehicle.

### III. Example UAV Components

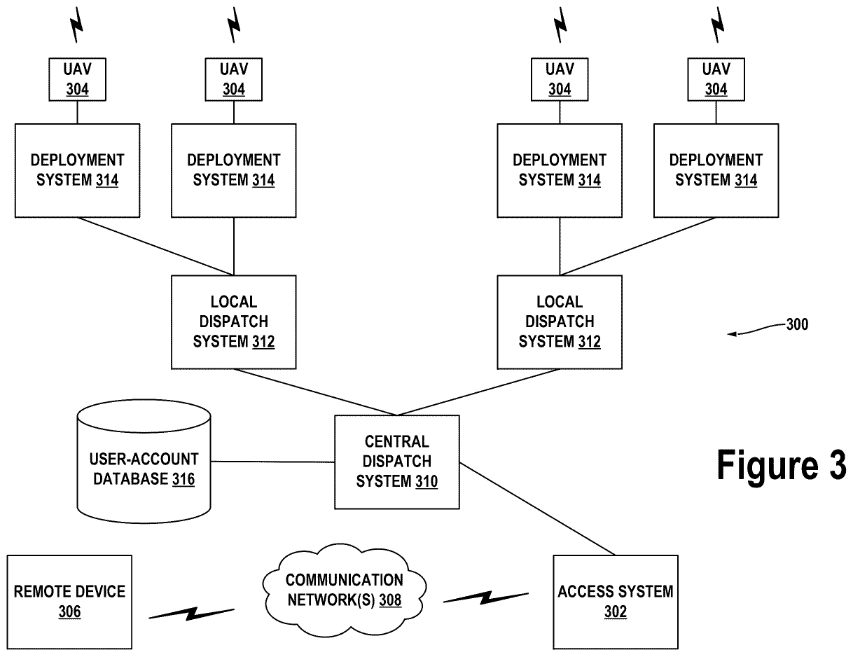

FIG. 2 is a simplified block diagram illustrating components of UAV 200, according to an example embodiment. UAV 200 may take the form of, or be similar in form to, one of UAVs 100, 120, 140, 160, and 180 described in reference to FIGS. 1A-1E. However, UAV 200 may also take other forms.

UAV 200 may include various types of sensors, and may include a computing system configured to provide the functionality described herein. In the illustrated embodiment, the sensors of UAV 200 include inertial measurement unit (IMU) 202, ultrasonic sensor(s) 204, and GPS receiver 206, among other possible sensors and sensing systems.

In the illustrated embodiment, UAV 200 also includes processor(s) 208. Processor 208 may be a general-purpose processor or a special purpose processor (e.g., digital signal processors, application specific integrated circuits, etc.). Processor(s) 208 can be configured to execute computer-readable program instructions 212 that are stored in data storage 210 and are executable to provide the functionality of a UAV described herein.

Data storage 210 may include or take the form of one or more computer-readable storage media that can be read or accessed by at least one processor 208. The one or more computer-readable storage media can include volatile and/or non-volatile storage components, such as optical, magnetic, organic or other memory or disc storage, which can be integrated in whole or in part with at least one of processor(s) 208. In some embodiments, data storage 210 can be implemented using a single physical device (e.g., one optical, magnetic, organic or other memory or disc storage unit), while in other embodiments, data storage 210 can be implemented using two or more physical devices.

As noted, data storage 210 can include computer-readable program instructions 212 and perhaps additional data, such as diagnostic data of UAV 200. As such, data storage 210 may include program instructions 212 to perform or facilitate some or all of the UAV functionality described herein. For instance, in the illustrated embodiment, program instructions 212 include navigation module 214 and tether control module 216.

In an illustrative embodiment, IMU 202 may include both an accelerometer and a gyroscope, which may be used together to determine an orientation of UAV 200. In particular, the accelerometer can measure the orientation of the vehicle with respect to earth, while the gyroscope measures the rate of rotation around an axis. IMUs are commercially available in low-cost, low-power packages. For instance, IMU 202 may take the form of or include a miniaturized MicroElectroMechanical System (MEMS) or a NanoElectroMechanical System (NEMS). Other types of IMUs may also be utilized.

IMU 202 may include other sensors, in addition to accelerometers and gyroscopes, which may help to better determine position and/or help to increase autonomy of UAV 200. Two examples of such sensors are magnetometers and pressure sensors. In some embodiments, a UAV may include a low-power, digital 3-axis magnetometer, which can be used to realize an orientation independent electronic compass for accurate heading information. However, other types of magnetometers may be utilized as well. Other examples are also possible. Further, note that a UAV could include some or all of the above-described inertia sensors as separate components from an IMU.

UAV 200 may also include a pressure sensor or barometer, which can be used to determine the altitude of UAV 200. Alternatively, other sensors, such as sonic altimeters or radar altimeters, can be used to provide an indication of altitude, which may help to improve the accuracy of and/or prevent drift of an IMU.

In a further aspect, UAV 200 may include one or more sensors that allow the UAV to sense objects in the environment. For instance, in the illustrated embodiment, UAV 200 includes ultrasonic sensor(s) 204. Ultrasonic sensor(s) 204 can determine the distance to an object by generating sound waves and determining the time interval between transmission of the wave and receiving the corresponding echo off an object. A typical application of an ultrasonic sensor for uncrewed vehicles or IMUs is low-level altitude control and obstacle avoidance. An ultrasonic sensor can also be used for vehicles that need to hover at a certain height or need to be capable of detecting obstacles. Other systems can be used to determine, sense the presence of, and/or determine the distance to nearby objects, such as a light detection and ranging (LIDAR) system, laser detection and ranging (LADAR) system, and/or an infrared or forward-looking infrared (FLIR) system, among other possibilities.

In some embodiments, UAV 200 may also include one or more imaging system(s). For example, one or more still and/or video cameras may be utilized by UAV 200 to capture image data from the UAV's environment. As a specific example, charge-coupled device (CCD) cameras or complementary metal-oxide-semiconductor (CMOS) cameras can be used with uncrewed vehicles. Such imaging sensor(s) have numerous possible applications, such as obstacle avoidance, localization techniques, ground tracking for more accurate navigation (e, g., by applying optical flow techniques to images), video feedback, and/or image recognition and processing, among other possibilities.

UAV 200 may also include GPS receiver 206. GPS receiver 206 may be configured to provide data that is typical of well-known GPS systems, such as the GPS coordinates of UAV 200. Such GPS data may be utilized by UAV 200 for various functions. As such, the UAV may use GPS receiver 206 to help navigate to the caller's location, as indicated, at least in part, by the GPS coordinates provided by their mobile device. Other examples are also possible.

Navigation module 214 may provide functionality that allows UAV 200 to, for example, move about its environment and reach a desired location. To do so, navigation module 214 may control the altitude and/or direction of flight by controlling the mechanical features of the UAV that affect flight (e.g., its rudder(s), elevator(s), aileron(s), and/or the speed of its propeller(s)).

In order to navigate UAV 200 to a target location, navigation module 214 may implement various navigation techniques, such as map-based navigation and localization-based navigation, for instance. With map-based navigation, UAV 200 may be provided with a map of its environment, which may then be used to navigate to a particular location on the map. With localization-based navigation, UAV 200 may be capable of navigating in an unknown environment using localization. Localization-based navigation may involve UAV 200 building its own map of its environment and calculating its position within the map and/or the position of objects in the environment. For example, as UAV 200 moves throughout its environment, UAV 200 may continuously use localization to update its map of the environment. This continuous mapping process may be referred to as simultaneous localization and mapping (SLAM). Other navigation techniques may also be utilized.

In some embodiments, navigation module 214 may navigate using a technique that relies on waypoints. In particular, waypoints are sets of coordinates that identify points in physical space. For instance, an air-navigation waypoint may be defined by a certain latitude, longitude, and altitude. Accordingly, navigation module 214 may cause UAV 200 to move from waypoint to waypoint, in order to ultimately travel to a final destination (e.g., a final waypoint in a sequence of waypoints).

In a further aspect, navigation module 214 and/or other components and systems of UAV 200 may be configured for “localization” to more precisely navigate to the scene of a target location. More specifically, it may be desirable in certain situations for a UAV to be within a threshold distance of the target location where payload 228 is being delivered by a UAV (e.g., within a few feet of the target destination). To this end, a UAV may use a two-tiered approach in which it uses a more-general location-determination technique to navigate to a general area that is associated with the target location, and then use a more-refined location-determination technique to identify and/or navigate to the target location within the general area.

For example, UAV 200 may navigate to the general area of a target destination where payload 228 is being delivered using waypoints and/or map-based navigation. The UAV may then switch to a mode in which it utilizes a localization process to locate and travel to a more specific location. For instance, if UAV 200 is to deliver a payload to a user's home, UAV 200 may need to be substantially close to the target location in order to avoid delivery of the payload to undesired areas (e.g., onto a roof, into a pool, onto a neighbor's property, etc.). However, a GPS signal may only get UAV 200 so far (e.g., within a block of the user's home). A more precise location-determination technique may then be used to find the specific target location.

Various types of location-determination techniques may be used to accomplish localization of the target delivery location once UAV 200 has navigated to the general area of the target delivery location. For instance, UAV 200 may be equipped with one or more sensory systems, such as, for example, ultrasonic sensors 204, infrared sensors (not shown), and/or other sensors, which may provide input that navigation module 214 utilizes to navigate autonomously or semi-autonomously to the specific target location.

As another example, once UAV 200 reaches the general area of the target delivery location (or of a moving subject such as a person or their mobile device), UAV 200 may switch to a “fly-by-wire” mode where it is controlled, at least in part, by a remote operator, who can navigate UAV 200 to the specific target location. To this end, sensory data from UAV 200 may be sent to the remote operator to assist them in navigating UAV 200 to the specific location.

As yet another example, UAV 200 may include a module that is able to signal to a passer-by for assistance in reaching the specific target delivery location. For example, the UAV 200 may display a visual message requesting such assistance in a graphic display or play an audio message or tone through speakers to indicate the need for such assistance, among other possibilities. Such a visual or audio message might indicate that assistance is needed in delivering UAV 200 to a particular person or a particular location, and might provide information to assist the passer-by in delivering UAV 200 to the person or location (e.g., a description or picture of the person or location, and/or the person or location's name), among other possibilities. Such a feature can be useful in a scenario in which the UAV is unable to use sensory functions or another location-determination technique to reach the specific target location. However, this feature is not limited to such scenarios.

In some embodiments, once UAV 200 arrives at the general area of a target delivery location, UAV 200 may utilize a beacon from a user's remote device (e.g., the user's mobile phone) to locate the person. Such a beacon may take various forms. As an example, consider the scenario where a remote device, such as the mobile phone of a person who requested a UAV delivery, is able to send out directional signals (e.g., via an RF signal, a light signal and/or an audio signal). In this scenario, UAV 200 may be configured to navigate by “sourcing” such directional signals-in other words, by determining where the signal is strongest and navigating accordingly. As another example, a mobile device can emit a frequency, either in the human range or outside the human range, and UAV 200 can listen for that frequency and navigate accordingly. As a related example, if UAV 200 is listening for spoken commands, then UAV 200 could utilize spoken statements, such as “I'm over here!” to source the specific location of the person requesting delivery of a payload.

In an alternative arrangement, a navigation module may be implemented at a remote computing device, which communicates wirelessly with UAV 200. The remote computing device may receive data indicating the operational state of UAV 200, sensor data from UAV 200 that allows it to assess the environmental conditions being experienced by UAV 200, and/or location information for UAV 200. Provided with such information, the remote computing device may determine altitudinal and/or directional adjustments that should be made by UAV 200 and/or may determine how UAV 200 should adjust its mechanical features (e.g., its rudder(s), elevator(s), aileron(s), and/or the speed of its propeller(s)) in order to effectuate such movements. The remote computing system may then communicate such adjustments to UAV 200 so it can move in the determined manner.

In a further aspect, UAV 200 includes one or more communication system(s) 218. Communications system(s) 218 may include one or more wireless interfaces and/or one or more wireline interfaces, which allow UAV 200 to communicate via one or more networks. Such wireless interfaces may provide for communication under one or more wireless communication protocols, such as Bluetooth, WiFi (e.g., an IEEE 802.11 protocol), Long-Term Evolution (LTE), WiMAX (e.g., an IEEE 802.16 standard), a radio-frequency ID (RFID) protocol, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network.

In some embodiments, UAV 200 may include communication systems 218 that allow for both short-range communication and long-range communication. For example, UAV 200 may be configured for short-range communications using Bluetooth and for long-range communications under a CDMA protocol. In such an embodiment, UAV 200 may be configured to function as a “hot spot;” or in other words, as a gateway or proxy between a remote support device and one or more data networks, such as a cellular network and/or the Internet. Configured as such, UAV 200 may facilitate data communications that the remote support device would otherwise be unable to perform by itself.

For example, UAV 200 may provide a WiFi connection to a remote device, and serve as a proxy or gateway to a cellular service provider's data network, which the UAV might connect to under an LTE or a 3G protocol, for instance. UAV 200 could also serve as a proxy or gateway to a high-altitude balloon network, a satellite network, or a combination of these networks, among others, which a remote device might not be able to otherwise access.

In a further aspect, UAV 200 may include power system(s) 220. Power system(s) 220 may include one or more batteries for providing power to UAV 200. In one example, the one or more batteries may be rechargeable and each battery may be recharged via a wired connection between the battery and a power supply and/or via a wireless charging system, such as an inductive charging system that applies an external time-varying magnetic field to an internal battery.

UAV 200 may employ various systems and configurations in order to transport and deliver payload 228. In some implementations, payload 228 of UAV 200 may include or take the form of a “package” designed to transport various goods to a target delivery location. For example, UAV 200 can include a compartment, in which an item or items may be transported. Such a package may one or more food items, purchased goods, medical items, or any other object(s) having a size and weight suitable to be transported between two locations by the UAV. In other embodiments, payload 228 may simply be the one or more items that are being delivered (e.g., without any package housing the items).

In some embodiments, payload 228 may be attached to the UAV and located substantially outside of the UAV during some or all of a flight by the UAV. For example, the package may be tethered or otherwise releasably attached below the UAV during flight to a target location. In an embodiment where a package carries goods below the UAV, the package may include various features that protect its contents from the environment, reduce aerodynamic drag on the system, and prevent the contents of the package from shifting during UAV flight.

In order to deliver the payload, the UAV may include winch system 221 controlled by tether control module 216 in order to lower payload 228 to the ground while UAV 200 hovers above. As shown in FIG. 2, winch system 221 may include tether 224, and tether 224 may be coupled to payload 228 by payload coupling apparatus 226. Tether 224 may be wound on a spool that is coupled to motor 222 of the UAV. Motor 222 may take the form of a DC motor (e.g., a servo motor) that can be actively controlled by a speed controller. Tether control module 216 can control the speed controller to cause motor 222 to rotate the spool, thereby unwinding or retracting tether 224 and lowering or raising payload coupling apparatus 226. In practice, the speed controller may output a desired operating rate (e.g., a desired RPM) for the spool, which may correspond to the speed at which tether 224 and payload 228 should be lowered towards the ground. Motor 222 may then rotate the spool so that it maintains the desired operating rate.

In order to control motor 222 via the speed controller, tether control module 216 may receive data from a speed sensor (e.g., an encoder) configured to convert a mechanical position to a representative analog or digital signal. In particular, the speed sensor may include a rotary encoder that may provide information related to rotary position (and/or rotary movement) of a shaft of the motor or the spool coupled to the motor, among other possibilities. Moreover, the speed sensor may take the form of an absolute encoder and/or an incremental encoder, among others. So in an example implementation, as motor 222 causes rotation of the spool, a rotary encoder may be used to measure this rotation. In doing so, the rotary encoder may be used to convert a rotary position to an analog or digital electronic signal used by tether control module 216 to determine the amount of rotation of the spool from a fixed reference angle and/or to an analog or digital electronic signal that is representative of a new rotary position, among other options. Other examples are also possible.

Based on the data from the speed sensor, tether control module 216 may determine a rotational speed of motor 222 and/or the spool and responsively control motor 222 (e.g., by increasing or decreasing an electrical current supplied to motor 222) to cause the rotational speed of motor 222 to match a desired speed. When adjusting the motor current, the magnitude of the current adjustment may be based on a proportional-integral-derivative (PID) calculation using the determined and desired speeds of motor 222. For instance, the magnitude of the current adjustment may be based on a present difference, a past difference (based on accumulated error over time), and a future difference (based on current rates of change) between the determined and desired speeds of the spool.

In some embodiments, tether control module 216 may vary the rate at which tether 224 and payload 228 are lowered to the ground. For example, the speed controller may change the desired operating rate according to a variable deployment-rate profile and/or in response to other factors in order to change the rate at which payload 228 descends toward the ground. To do so, tether control module 216 may adjust an amount of braking or an amount of friction that is applied to tether 224. For example, to vary the tether deployment rate, UAV 200 may include friction pads that can apply a variable amount of pressure to tether 224. As another example, UAV 200 can include a motorized braking system that varies the rate at which the spool lets out tether 224. Such a braking system may take the form of an electromechanical system in which motor 222 operates to slow the rate at which the spool lets out tether 224. Further, motor 222 may vary the amount by which it adjusts the speed (e.g., the RPM) of the spool, and thus may vary the deployment rate of tether 224. Other examples are also possible.

In some embodiments, tether control module 216 may be configured to limit the motor current supplied to motor 222 to a maximum value. With such a limit placed on the motor current, there may be situations where motor 222 cannot operate at the desired rate specified by the speed controller. For instance, there may be situations where the speed controller specifies a desired operating rate at which motor 222 should retract tether 224 toward UAV 200, but the motor current may be limited such that a large enough downward force on tether 224 would counteract the retracting force of motor 222 and cause tether 224 to unwind instead. A limit on the motor current may be imposed and/or altered depending on an operational state of UAV 200.

In some embodiments, tether control module 216 may be configured to determine a status of tether 224 and/or payload 228 based on the amount of current supplied to motor 222. For instance, if a downward force is applied to tether 224 (e.g., if payload 228 is attached to tether 224 or if tether 224 gets snagged on an object when retracting toward UAV 200), tether control module 216 may need to increase the motor current in order to cause the determined rotational speed of motor 222 and/or spool to match the desired speed. Similarly, when the downward force is removed from tether 224 (e.g., upon delivery of payload 228 or removal of a tether snag), tether control module 216 may need to decrease the motor current in order to cause the determined rotational speed of motor 222 and/or spool to match the desired speed. As such, tether control module 216 may be configured to monitor the current supplied to motor 222. For instance, tether control module 216 could determine the motor current based on sensor data received from a current sensor of the motor or a current sensor of power system 220. In any case, based on the current supplied to motor 222, tether control module 216 may determine if payload 228 is attached to tether 224, if someone or something is pulling on tether 224, and/or if payload coupling apparatus 226 is pressing against UAV 200 after retracting tether 224. Other examples are possible as well.

During delivery of payload 228, payload coupling apparatus 226 can be configured to secure payload 228 while being lowered from the UAV by tether 224, and can be further configured to release payload 228 upon reaching ground level. Payload coupling apparatus 226 can then be retracted to the UAV by reeling in tether 224 using motor 222.

In some implementations, payload 228 may be passively released once it is lowered to the ground. For example, a passive release mechanism may include one or more swing arms adapted to retract into and extend from a housing. An extended swing arm may form a hook on which payload 228 may be attached. Upon lowering the release mechanism and payload 228 to the ground via a tether, a gravitational force as well as a downward inertial force on the release mechanism may cause payload 228 to detach from the hook allowing the release mechanism to be raised upwards toward the UAV. The release mechanism may further include a spring mechanism that biases the swing arm to retract into the housing when there are no other external forces on the swing arm. For instance, a spring may exert a force on the swing arm that pushes or pulls the swing arm toward the housing such that the swing arm retracts into the housing once the weight of payload 228 no longer forces the swing arm to extend from the housing. Retracting the swing arm into the housing may reduce the likelihood of the release mechanism snagging payload 228 or other nearby objects when raising the release mechanism toward the UAV upon delivery of payload 228.

Active payload release mechanisms are also possible. For example, sensors such as a barometric pressure based altimeter and/or accelerometers may help to detect the position of the release mechanism (and the payload) relative to the ground. Data from the sensors can be communicated back to the UAV and/or a control system over a wireless link and used to help in determining when the release mechanism has reached ground level (e.g., by detecting a measurement with the accelerometer that is characteristic of ground impact). In other examples, the UAV may determine that the payload has reached the ground based on a weight sensor detecting a threshold low downward force on the tether and/or based on a threshold low measurement of power drawn by the winch when lowering the payload.

Other systems and techniques for delivering a payload, in addition or in the alternative to a tethered delivery system are also possible. For example, UAV 200 could include an air-bag drop system or a parachute drop system. Alternatively, UAV 200 carrying a payload could simply land on the ground at a delivery location. Other examples are also possible.

### IV. Example UAV Deployment Systems

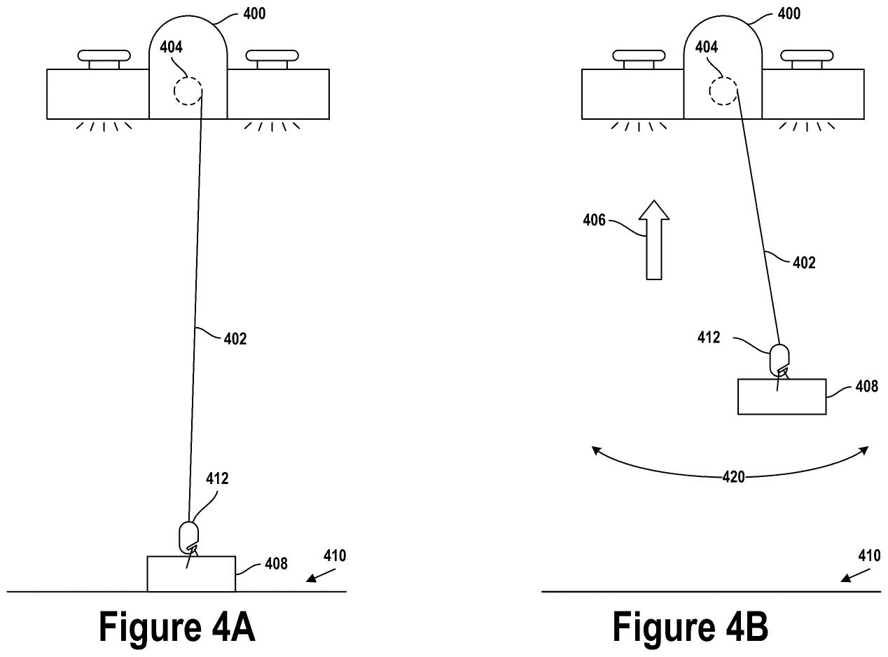

UAV systems may be implemented in order to provide various UAV-related services. In particular, UAVs may be provided at a number of different launch sites that may be in communication with regional and/or central control systems. Such a distributed UAV system may allow UAVs to be quickly deployed to provide services across a large geographic area (e.g., that is much larger than the flight range of any single UAV). For example, UAVs capable of carrying payloads may be distributed at a number of launch sites across a large geographic area (possibly even throughout an entire country, or even worldwide), in order to provide on-demand transport of various items to locations throughout the geographic area. FIG. 3 is a simplified block diagram illustrating a distributed UAV system 300, according to an example embodiment.

In the illustrative UAV system 300, access system 302 may allow for interaction with, control of, and/or utilization of a network of UAVs 304. In some embodiments, access system 302 may be a computing system that allows for human-controlled dispatch of UAVs 304. As such, the control system may include or otherwise provide a user interface through which a user can access and/or control UAVs 304.

In some embodiments, dispatch of UAVs 304 may additionally or alternatively be accomplished via one or more automated processes. For instance, access system 302 may dispatch one of UAVs 304 to transport a payload to a target location, and the UAV may autonomously navigate to the target location by utilizing various on-board sensors, such as a GPS receiver and/or other various navigational sensors.

Further, access system 302 may provide for remote operation of a UAV. For instance, access system 302 may allow an operator to control the flight of a UAV via its user interface. As a specific example, an operator may use access system 302 to dispatch one of UAVs 304 to a target location. The dispatched UAV may then autonomously navigate to the general area of the target location. At this point, the operator may use access system 302 to take control of the dispatched UAV and navigate the dispatched UAV to the target location (e.g., to a particular person to whom a payload is being transported). Other examples of remote operation of a UAV are also possible.

In an illustrative embodiment, UAVs 304 may take various forms. For example, each of UAVs 304 may be a UAV such as those illustrated in FIGS. 1A, 1B, 1C, 1D, 1E, or 2. However, UAV system 300 may also utilize other types of UAVs without departing from the scope of the invention. In some implementations, all of UAVs 304 may be of the same or a similar configuration. However, in other implementations, UAVs 304 may include a number of different types of UAVs. For instance, UAVs 304 may include a number of types of UAVs, with each type of UAV being configured for a different type or types of payload delivery capabilities.

UAV system 300 may further include remote device 306, which may take various forms. Generally, remote device 306 may be any device through which a direct or indirect request to dispatch a UAV can be made. Note that an indirect request may involve any communication that may be responded to by dispatching a UAV, such as requesting a package delivery. In an example embodiment, remote device 306 may be a mobile phone, tablet computer, laptop computer, personal computer, or any network-connected computing device. Further, in some instances, remote device 306 may not be a computing device. As an example, a standard telephone, which allows for communication via plain old telephone service (POTS), may serve as remote device 306. Other types of remote devices are also possible.

Further, remote device 306 may be configured to communicate with access system 302 via one or more types of communication network(s) 308. For example, remote device 306 may communicate with access system 302 (or a human operator of access system 302) by communicating over a POTS network, a cellular network, and/or a data network such as the Internet. Other types of networks may also be utilized.

In some embodiments, remote device 306 may be configured to allow a user to request pick-up of one or more items from a certain source location and/or delivery of one or more items to a desired location. For example, a user could request UAV delivery of a package to their home via their mobile phone, tablet, or laptop. As another example, a user could request dynamic delivery to wherever they are located at the time of delivery. To provide such dynamic delivery, UAV system 300 may receive location information (e.g., GPS coordinates, etc.) from the user's mobile phone, or any other device on the user's person, such that a UAV can navigate to the user's location (as indicated by their mobile phone).

In an illustrative arrangement, central dispatch system 310 may be a server or group of servers, which is configured to receive dispatch messages requests and/or dispatch instructions from access system 302. Such dispatch messages may request or instruct central dispatch system 310 to coordinate the deployment of UAVs to various target locations. Central dispatch system 310 may be further configured to route such requests or instructions to one or more local dispatch systems 312. To provide such functionality, central dispatch system 310 may communicate with access system 302 via a data network, such as the Internet or a private network that is established for communications between access systems and automated dispatch systems.

In the illustrated configuration, central dispatch system 310 may be configured to coordinate the dispatch of UAVs 304 from a number of different local dispatch systems 312. As such, central dispatch system 310 may keep track of which ones of UAVs 304 are located at which ones of local dispatch systems 312, which UAVs 304 are currently available for deployment, and/or which services or operations each of UAVs 304 is configured for (in the event that a UAV fleet includes multiple types of UAVs configured for different services and/or operations). Additionally or alternatively, each local dispatch system 312 may be configured to track which of its associated UAVs 304 are currently available for deployment and/or are currently in the midst of item transport.

In some cases, when central dispatch system 310 receives a request for UAV-related service (e.g., transport of an item) from access system 302, central dispatch system 310 may select a specific one of UAVs 304 to dispatch. Central dispatch system 310 may accordingly instruct local dispatch system 312 that is associated with the selected UAV to dispatch the selected UAV. Local dispatch system 312 may then operate its associated deployment system 314 to launch the selected UAV. In other cases, central dispatch system 310 may forward a request for a UAV-related service to one of local dispatch systems 312 that is near the location where the support is requested and leave the selection of a particular one of UAVs 304 to local dispatch system 312.

In an example configuration, local dispatch system 312 may be implemented as a computing system at the same location as deployment system(s) 314 that it controls. For example, a particular one of local dispatch system 312 may be implemented by a computing system installed at a building, such as a warehouse, where deployment system(s) 314 and UAV(s) 304 that are associated with the particular one of local dispatch systems 312 are also located. In other embodiments, the particular one of local dispatch systems 312 may be implemented at a location that is remote to its associated deployment system(s) 314 and UAV(s) 304.

Numerous variations on and alternatives to the illustrated configuration of UAV system 300 are possible. For example, in some embodiments, a user of remote device 306 could request delivery of a package directly from central dispatch system 310. To do so, an application may be implemented on remote device 306 that allows the user to provide information regarding a requested delivery, and generate and send a data message to request that UAV system 300 provide the delivery. In such an embodiment, central dispatch system 310 may include automated functionality to handle requests that are generated by such an application, evaluate such requests, and, if appropriate, coordinate with an appropriate local dispatch system 312 to deploy a UAV.

Further, some or all of the functionality that is attributed herein to central dispatch system 310, local dispatch system(s) 312, access system 302, and/or deployment system(s) 314 may be combined in a single system, implemented in a more complex system (e.g., having more layers of control), and/or redistributed among central dispatch system 310, local dispatch system(s) 312, access system 302, and/or deployment system(s) 314 in various ways.

Yet further, while each local dispatch system 312 is shown as having two associated deployment systems 314, a given local dispatch system 312 may alternatively have more or fewer associated deployment systems 314. Similarly, while central dispatch system 310 is shown as being in communication with two local dispatch systems 312, central dispatch system 310 may alternatively be in communication with more or fewer local dispatch systems 312.

In a further aspect, deployment systems 314 may take various forms. In some implementations, some or all of deployment systems 314 may be a structure or system that passively facilitates a UAV taking off from a resting position to begin a flight. For example, some or all of deployment systems 314 may take the form of a landing pad, a hangar, and/or a runway, among other possibilities. As such, a given deployment system 314 may be arranged to facilitate deployment of one UAV 304 at a time, or deployment of multiple UAVs (e.g., a landing pad large enough to be utilized by multiple UAVs concurrently).

Additionally or alternatively, some or all of deployment systems 314 may take the form of or include systems for actively launching one or more of UAVs 304. Such launch systems may include features that provide for an automated UAV launch and/or features that allow for a human-assisted UAV launch. Further, a given deployment system 314 may be configured to launch one particular UAV 304, or to launch multiple UAVs 304.

Note that deployment systems 314 may also be configured to passively facilitate and/or actively assist a UAV when landing. For example, the same landing pad could be used for take-off and landing. Deployment system 314 could also include other structures and/or systems to assist and/or facilitate UAV landing processes.

Deployment systems 314 may further be configured to provide additional functions, including for example, diagnostic-related functions such as verifying system functionality of the UAV, verifying functionality of devices that are housed within a UAV (e.g., a payload delivery apparatus), and/or maintaining devices or other items that are housed in the UAV (e.g., by monitoring a status of a payload such as its temperature, weight, etc.).

In some embodiments, local dispatch systems 312 (along with their respective deployment system(s) 314 may be strategically distributed throughout an area such as a city. For example, local dispatch systems 312 may be strategically distributed such that each local dispatch systems 312 is proximate to one or more payload pickup locations (e.g., near a restaurant, store, or warehouse). However, local dispatch systems 312 may be distributed in other ways, depending upon the particular implementation.

As an additional example, kiosks that allow users to transport packages via UAVs may be installed in various locations. Such kiosks may include UAV launch systems, and may allow a user to provide their package for loading onto a UAV and pay for UAV shipping services, among other possibilities. Other examples are also possible.

In a further aspect, UAV system 300 may include or have access to user-account database 316. User-account database 316 may include data for a number of user accounts, and which are each associated with one or more person. For a given user account, user-account database 316 may include data related to or useful in providing UAV-related services. Typically, the user data associated with each user account is optionally provided by an associated user and/or is collected with the associated user's permission.

Further, in some embodiments, a person may be required to register for a user account with UAV system 300, if they wish to be provided with UAV-related services by UAVs 304 from UAV system 300. As such, user-account database 316 may include authorization information for a given user account (e.g., a user name and password), and/or other information that may be used to authorize access to a user account.

In some embodiments, a person may associate one or more of their devices with their user account, such that they can access the services of UAV system 300. For example, when a person uses an associated mobile phone to, e.g., place a call to an operator of access system 302 or send a message requesting a UAV-related service to a dispatch system, the phone may be identified via a unique device identification number, and the call or message may then be attributed to the associated user account. Other examples are also possible.

### V. Example Payload Weighing Maneuvers

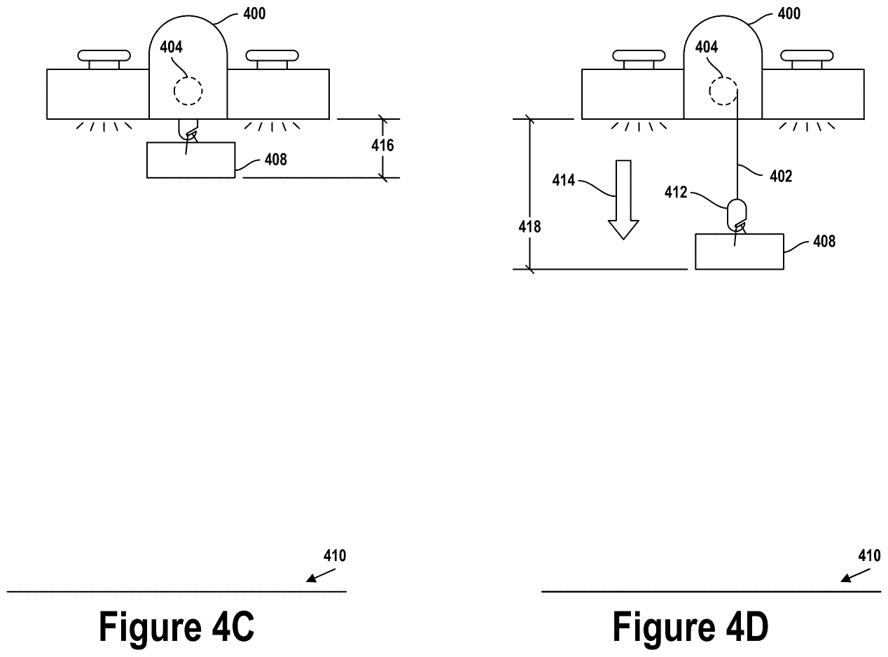

FIGS. 4A, 4B, 4C, and 4D illustrate aspects of an example process for determining a mass of a payload coupled to an aerial vehicle using a tether. Specifically, FIGS. 4A, 4B, 4C, and 4D illustrate aerial vehicle 400 that includes a winch system configured for pickup and drop-off of payloads. Aerial vehicle 400 may represent UAV 100 and/or UAV 200. The operations discussed herein may be performed by, for example, a control system of aerial vehicle 400, which may be provided on aerial vehicle 400, provided on a computing device communicatively connected to aerial vehicle 400, and/or distributed therebetween. The winch system may include tether 402 coupled to (e.g., wound around) spool 404, a motor configured to apply a torque to spool 404, and payload coupling apparatus 412. FIGS. 4A and 4B show aerial vehicle 400 and the winch system being used to pick up payload 408, as indicated by arrow 406, and retract payload 408 towards aerial vehicle 400.

As shown in FIG. 4A, spool 404 may be operated to unwind tether 402 to lower payload coupling apparatus 412 from aerial vehicle 400 towards ground surface 410. Aerial vehicle 400 and the winch system thereof may be controlled to connect payload coupling apparatus 412 to payload 408. As shown in FIG. 4B, once payload coupling apparatus 412 is connected to payload 408, spool 404 may be operated to wind tether 402 to lift payload coupling apparatus 412 and/or payload 408 from ground surface 410 to aerial vehicle 400. As payload 408 is lifted by the winch system of aerial vehicle 400, payload 408 may swing, sway, and/or oscillate relative to aerial vehicle 400, as indicated by arc 420. Such swinging, swaying, and/or oscillation may cause the force applied to tether 402 by payload 408 to vary widely over time, thus making it difficult to accurately determine a mass of payload 408 on the basis of forces experienced by tether 402 as payload 408 is initially lifted up towards aerial vehicle 400.

In some implementations, rather than being picked up from ground surface 410, payload 408 may instead be picked up from and/or using a payload loading apparatus configured to facilitate connection of payload coupling apparatus 412 to payload 408. For example, the payload loading apparatus may include an autoloader device as described in U.S. Patent Application Publication No. 2023/0400864A1. Payload 408 may be an item intended for transport from a pickup location to a delivery destination, and may include a package, parcel, container, or other structure that is configured to interface with payload coupling apparatus 412. Aerial vehicle 400 and the winch system thereof may operate to autonomously pick-up and/or drop-off payload 408 in a controlled manner while aerial vehicle 400 hovers above and/or moves relative to payload 408 and/or the payload loading apparatus.

As shown in FIG. 4C, tether 402 may be reeled in until payload 408 is retracted to within first distance 416 of aerial vehicle 400 and/or part(s) thereof. For example, tether 402 may be reeled in until payload coupling apparatus 412 and/or at least part of payload 408 (e.g., a top surface of payload 408) come into contact with a body of aerial vehicle 400, thereby stabilizing payload 408 relative to aerial vehicle 400. In some implementations, first distance 416 may be predetermined and/or may define a first threshold distance. First distance 416 may be defined and/or measured based on and/or using an angular position of spool 404 and/or visual markings on tether 402, among other possibilities. Thus, although first distance 416 is shown as being measured between a bottom surface of aerial vehicle 400 and a bottom surface of payload 408, it is to be understood that first distance 416 may alternatively and equivalently be expressed as a first angular position of spool 404, a first deployed length of tether 402, and/or a first distance between a top surface of payload 408 and the bottom surface of aerial vehicle 400, among other possibilities.

In some cases, payload 408 may be maintained within first distance 416 (e.g., in the position shown in FIG. 4C) for at least a first time period (e.g., 1 second, 2 seconds, 3 seconds, etc.) to suppress any remaining swaying, swinging, and/or oscillation of payload 408. For example, the first time period may be a predetermined time period. In some cases, payload 408 may be maintained within first distance 416 until sensor data (e.g., IMU data, image data, etc.) representing motion of payload 408 indicates that some, most, or all swaying, swinging, and/or oscillation of payload 408 has been suppressed.

After payload 408 is brought within first distance 416 and/or at least some of the swaying, swinging, and/or oscillation of payload 408 has been suppressed, aerial vehicle 400 may be configured to lower payload 408 by at least second distance 418, as indicated by arrow 414. For example, as the weight of payload 408 causes tether 402 to be unspooled, the motor may be controlled to resist the weight of payload 408, resulting in spool 404 unwinding tether 402 and allowing payload 408 to descend over second distance 418. In some cases, the motor may control spool 404 to rotate at a substantially constant angular velocity, thus causing payload 408 to descend at a substantially constant linear velocity (i.e., an acceleration that is substantially equal to zero).

In some cases, aerial vehicle 400 may attempt to hover in a fixed position in space while payload 408 is lowered over second distance 418, and aerial vehicle 400 may thus provide a substantially and/or approximately fixed position in space relative to which payload 408 descends. Accordingly, movements of aerial vehicle 400 might not inadvertently cause payload 408 to start swinging, swaying, and/or oscillating relative to aerial vehicle 400.

When payload 408 descends at a substantially constant velocity and/or no stray forces are applied thereto, the tension experienced by tether 402 may be approximately and/or substantially equal to a weight of payload 408. In cases where payload 408 descends with a changing velocity (i.e., an acceleration that is not substantially equal to zero), the changing velocity may be accounted for when calculating the mass of payload 408. As one example, data samples corresponding to time periods where the descent velocity of payload 408 is not substantially constant (e.g., changes by more than a threshold velocity) may be removed, and thus not considered as part of the calculation of the mass of payload 408 (e.g., the mass of payload may be based exclusively on data samples corresponding to time periods where payload 408 descends at the substantially constant velocity). As another example, a machine learning model may process data samples from both (i) time periods when payload 408 descends at the substantially constant velocity and (ii) time periods when the descent velocity of payload 408 deviates from the substantially constant velocity. The machine learning model may be configured through training to account and/or compensate for deviations from the substantially constant velocity when determining the mass of payload 408.

In some implementations, second distance 418 may be predetermined and/or may define a second threshold distance. As with first distance 416, second distance 418 may be defined and/or measured based on and/or using an angular position of spool 404 and/or visual markings on tether 402, among other possibilities. Thus, although second distance 418 is shown as being measured between a bottom surface of aerial vehicle 400 and a bottom surface of payload 408, it is to be understood that second distance 418 may alternatively and equivalently be expressed as a second angular position of spool 404, a second deployed length of tether 402, and/or a second distance between a top surface of payload 408 and the bottom surface of aerial vehicle 400, among other possibilities.

While payload 408 is lowered over second distance 418, one or more sensors and/or components of aerial vehicle 400 may be configured to generate data that indicates a tension experienced by tether 402. For example, the data may include an electrical current value representing an amount of electrical current that has been commanded to and/or drawn by the motor of the winch system. The electrical current value may be used in combination with a torque constant of the motor to determine a torque applied to the spool by the motor. The torque applied to the spool may be used in combination with an effective radius of the spool (which may vary depending on the deployed length of tether 402) to determine a force applied to tether 402 to counteract the weight of payload 408. As another example, the data may include force data obtained from a load cell connected between payload coupling apparatus 412 and tether 402.

In some implementations, the data may also include other data that might not directly represent the amount of tension on tether 402, but that may be used to account for and/or compensate for various sources of friction in the winch system and/or variations in the descent velocity of payload 408, among others. For example, the data may include angular position value(s) and/or an angular velocity values(s) obtained from an encoder coupled to the motor and/or spool 404. As another example, the data may include environmental conditions data (e.g., wind, pressure, temperature, etc.) and/or flight control data that represents flight maneuvers performed by aerial vehicle 400 during descent of payload 408 over second distance 418.

In some cases, the data that indicates the tension experienced by tether 402 may include a plurality of data points/samples. For example, the plurality of data points/samples may include at least a threshold number of data points/samples (e.g., 10 samples, 20 samples, 30 samples, etc.). For example, the threshold number of data points/samples may be selected to improve and/or maximize the likelihood of obtaining data during a time period corresponding to payload 408 descending at the substantially constant velocity. Second distance 418 and/or the descent velocity of payload 408 may be selected to allow aerial vehicle 400 to obtain at least the threshold number of data points/samples during descent of payload 408. For example, the threshold number of data points/samples may be selected such that outlier measurements observed during descent of payload 408 are unlikely to significantly affect and/or skew a filtered version of the plurality of data points/samples.

The data that indicates the tension experienced by tether 402, possibly along with other data collected during descent of payload 408 over second distance 418, may be used by the control system to determine a mass of payload 408. Specifically, in the absence of stray forces (e.g., oscillations, friction, etc.) on payload 408, the tension experienced by tether 402 may be substantially equal and opposite in direction to the weight of payload 408 due to gravity. Thus, the weight of payload 408 may be divided by the acceleration due to gravity to determine the mass of payload 408. In the presence of stray forces, these stray forces may be explicitly or implicitly estimated and subtracted from the tension experienced by tether 402 to determine the weight of payload 408.

The mass of payload 408 may be used to determine a maneuver to be performed by aerial vehicle 400. Specifically, the mass of the payload may be compared to a threshold mass, which may represent a maximum payload mass that aerial vehicle 400 is configured to transport. Accordingly, when the mass of payload 408 is greater than the threshold mass, payload 408 may be rejected from transport by aerial vehicle 400, and the control system may determine that, for example, payload 408 is to be dropped off by aerial vehicle 400 at or near a pick-up location of payload 408 (e.g., at or near a ground surface 410, possibly near the payload loading apparatus from which payload 408 was picked up). When the mass of payload 408 is less than the threshold mass, payload 408 may be accepted for transport by aerial vehicle 400, and the control system may determine to transport payload 408 by aerial vehicle 400 to a destination location assigned to payload 408. Before transporting payload 408, aerial vehicle 400 may be configured to reel in tether 402 to bring payload 408 closer to aerial vehicle 400 for transport. For example, tether 402 may be reeled in until payload 408 is brought within first distance 416 of aerial vehicle 400, thereby stabilizing payload 408 during transport.

In some implementations, the mass of payload 408 may additionally or alternatively be determined based on data collected during initial retraction of payload 408 towards aerial vehicle 400, as illustrated in FIGS. 4A and 4B. For example, aerial vehicle 400 may collect initial data indicative of an initial force applied to tether 402 by payload 408 as payload 408 is retracted towards aerial vehicle 400. The initial data may be noisier and/or less reliable than the data collected while payload is lowered over second distance 418 for several reasons. First, payload 408 and aerial vehicle 400 might not be aligned horizontally during and after pick-up of payload 408, which may make payload 408 more likely to sway, swing, and/or oscillate, as indicated by arc 420. Second, the ascending path (arrow 406) may be longer than the descending path (arrow 414), which may allow more time for oscillations, swaying, and/or swinging to develop and progress on the way up than on the way down. Third, pick-up of payload 408 may involve the application of greater forces than the descent of payload 408, and these greater forces (i) are more likely to initiate and/or drive the oscillations, swaying, and/or swinging and (ii) may cause more frictional forces which may increase in proportion to the speed with which the motor and components connected thereto are driven.

Nevertheless, the initial data may be used to determine an initial estimate of the mass of payload 408. This initial estimate of the mass of payload 408 may be less accurate than the mass of the payload as determined by lowering payload 408 over second distance 418. In some cases, if the initial estimate of the mass of payload 408 is less than an initial mass threshold, redetermination of the mass by lowering payload 408 over second distance 418 may be omitted. For example, the initial mass threshold may be selected such that a payload having an actual mass that is less than the maximum mass threshold will not, given the error distribution of the initial mass estimates, exceed the initial mass threshold with more than a threshold frequency (e.g., 0.1% of the time, 1% of the time, etc.). The threshold frequency and/or the initial mass threshold may be selected based on how frequently payloads are allowed to exceed the maximum mass threshold.

Redetermination of the mass by lowering payload 408 over second distance 418 may be performed based on and/or in response to the initial estimate of the mass of payload 408 being greater than the initial mass threshold. Thus, in some implementations, payload 408 may be lowered over second distance 418 to more accurately determine the mass of payload 408 when the initial mass estimate indicates that the mass of payload 408 is likely to exceed the maximum mass threshold. Accordingly, the process of lowering payload 408 over second distance 418 may be referred to as a reweigh maneuver when it is performed after and/or based on the initial estimate of the mass of payload determined based on data collected while payload 408 is retracted towards aerial vehicle 400.

In some implementations, the initial estimate of the mass of payload 408 may be fused and/or combined (e.g., using a machine learning model) with the mass of payload 408 determined based on lowering payload 408 over second distance 418, and such fusion may result in an estimate of the mass of payload 408 that is more accurate that either of these measurements alone. For example, the machine learning model may be configured to process data samples from both the retraction of payload 408 and the lowering of payload 408, and the machine learning model may be configured to account for the reliability of each group of measurements in indicating the mass of payload 408.

### VI. Example Force Graphs

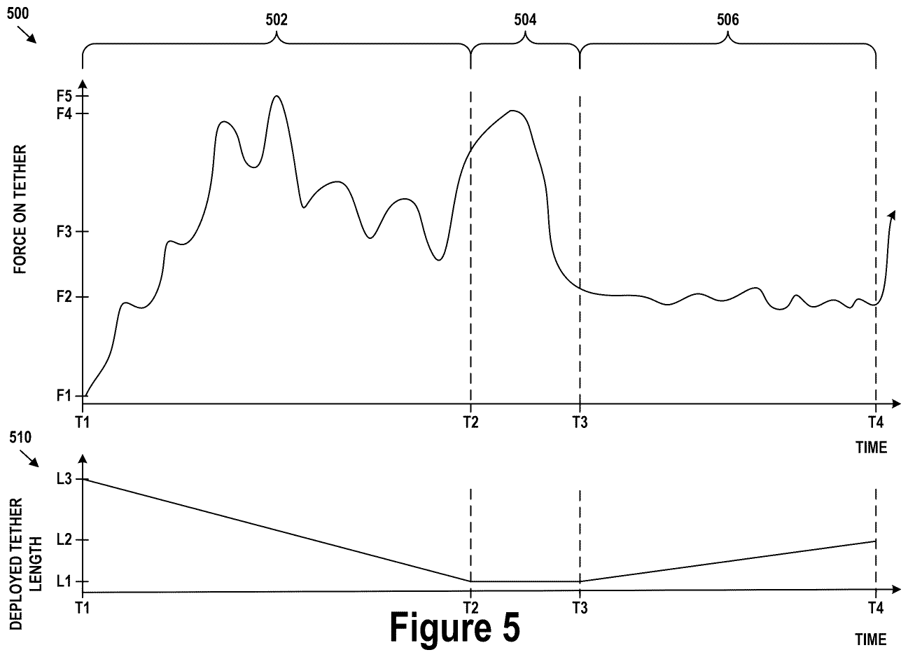

FIG. 5 illustrates graph 500 of forces applied to the tether 402 of aerial vehicle 400 over time, and graph 510 of a deployed length of tether 402 over time. Section 502 of graphs 500 and 510 ranges from time T1 to time T2 corresponds to retraction of payload 408 towards aerial vehicle 400 after pickup of payload 408 (e.g., as shown in FIGS. 4A and 4B). Section 504 of graphs 500 and 510 ranges from time T2 to time T3 and corresponds to payload 408 being placed and maintained within first distance 416 (e.g., as shown in FIG. 4C). Section 506 of graphs 500 and 510 ranges from time T3 to time T4 corresponds to payload 408 being allowed to descent (e.g., with a substantially constant velocity) over second distance 418 beneath aerial vehicle 400 (e.g., as shown in FIG. 4D).

Specifically, in section 502, the deployed length of tether 402 is reduced from length L3 to length L1, and the force applied to tether 402 by payload 408 ranges from force F1 to force F5. In section 504, the deployed length of tether 402 is maintained at length L1, and the force applied to tether 402 by payload 408 ranges from force F4 to slightly above force F2. In section 506, the deployed length of tether 402 increases from length L1 to length L2, and the force applied to tether 402 by payload 408 varies somewhat around force F2. Graph 510 includes, for clarity of illustration, straight lines to illustrate the deployed length of tether 402, and it is to be understood that, in practice, various versions of graph 510 may include at least some variations about these straight lines as components of aerial vehicle 400 operate to cause actual component operation(s) (e.g., current, velocity, position, etc.) to match commanded component operation(s).

As can be seen in section 502 of graph 500, the force applied by payload 408 to tether 402 varies significantly more in section 502 than in section 506. For example, the force on tether 402 in section 506 varies slightly about force F2, while the force on tether 402 in section 502 varies much more widely between force F1 and force F5. In the example shown, force F3 represents the average force on tether 402 in section 502, force F2 represents the average force on tether 402 in section 506, and the weight of payload 408 is approximately equal to force F2. Thus, the initial force determination based on data from section 502 provides an overestimate of the weight (and thus mass) of payload 408, while the force determination based on data from section 506 provides a relatively accurate estimate of the weight (and thus mass) of payload 408.

As can be seen in section 504 of graph 500, the force applied by payload 408 to tether 402 varies less significantly in section 504 than in section 502 at least because oscillations, swaying, and/or swinging of payload 408 are reduced as payload 408 comes closer to aerial vehicle 400. However, holding payload 408 in a fixed position relative to aerial vehicle 400 involves the motor of the winch system operating to counteract both the weight of payload 408 and static friction of the winch system. The static friction is nonlinear and increases until the motor overcomes the maximum static friction limit of the winch system (i.e., static friction is “self-adjusting”), making it difficult to determine how the motor's force is divided between counteracting the weight of payload 408 and the static friction of the winch system. On the other hand, the kinetic friction experienced while lowering payload 408 is linear and not self-adjusting, making it easier to model. Thus, the average force based on data from section 502 provides an overestimate of the weight (and thus mass) of payload 408, while the force determination based on data from section 506 provides a relatively accurate estimate of the weight (and thus mass) of payload 408.

Accordingly, the lowering of payload 408 over second distance 418 (e.g., at the substantially constant velocity) during section 506 allows for a more accurate determination of the mass of payload 408 than (i) retraction of payload 408 towards aerial vehicle 400 during section 502 and/or (ii) holding of payload 408 in a fixed position relative to aerial vehicle 400 during section 504. Specifically, the lowering of payload 408 over second distance 418 allows some, most, or all of the stray forces on payload 408 to be reduced and/or eliminated, thus allowing the tension on tether 402 to be primarily indicative of and/or substantially equal to the weight of payload 408.

### VII. Example Models for Payload Mass Determination

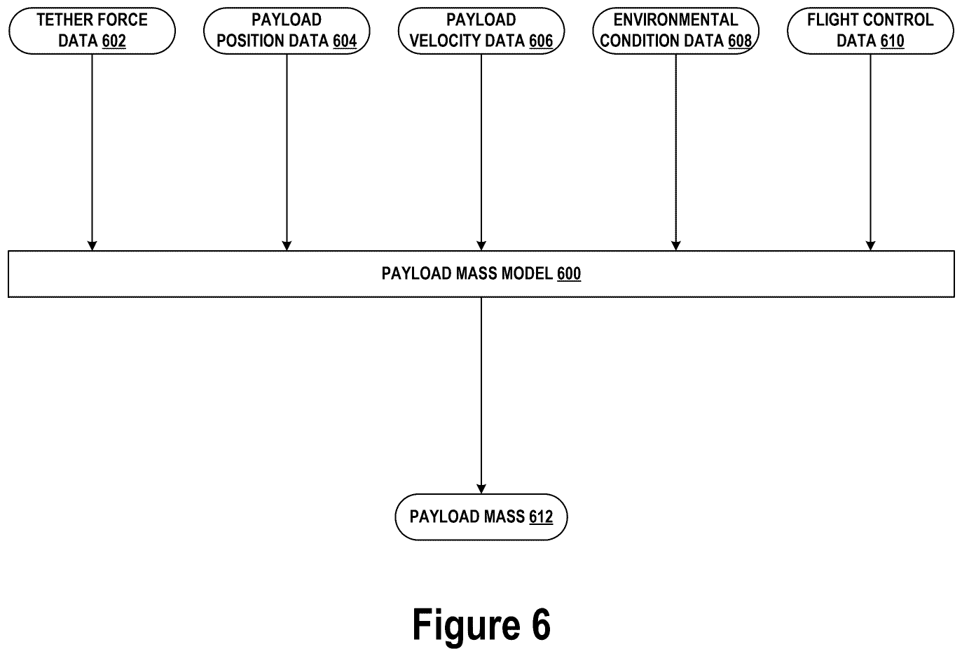

FIG. 6 illustrates an example model configured to determine a mass of a payload (e.g., payload 408) based on data collected during winch-down and/or winch-up of the payload. Specifically, payload mass model 600 may be configured to determine payload mass 612 based on tether force data 602, payload position data 604, payload velocity data 606, environmental condition data 608, and/or flight control data 610, (collectively “data 602-610”) among other possible inputs.

Tether force data 602 may include motor current data, which may include one or more electrical current values that represent an electrical current commanded to the motor of the winch system and/or an electrical current actually drawn by the motor. Tether force data 602 may include other values that allow the motor current data to be converted into a force measurement, such as the motor torque constant and the effective radius of spool 404, among others. Alternatively or additionally, tether force data 602 may include force data obtained from, for example, a load cell coupled between tether 402 and payload coupling apparatus 412. Thus, tether force data 602 may directly and/or indirectly represent the force applied to tether 402 by payload 408.

Payload position data 604 may represent a position over time of payload 408 relative to aerial vehicle 400. Payload velocity data 606 may represent a velocity over time of payload 408 relative to aerial vehicle 400. As one example, payload position data 604 and/or payload velocity data 606 may be generated and/or determined using a position encoder provided on the motor, the spool, and/or other rotatable components of the winch system. As another example, payload position data 604 and/or payload velocity data 606 may be generated and/or determined using one or more cameras on aerial vehicle 400. The one or more cameras may be configured to capture images of payload 408 from a perspective of (e.g., looking down from) aerial vehicle 400, and the position and/or velocity of payload 408 may be determined based on a size and/or a position of payload 408 within the images.

Environmental condition data 608 may represent physical conditions present in an environment in which aerial vehicle 400 is operating, and may include temperature, pressure, wind speed and/or direction, and/or humidity, among others. Flight control data 610 may include measurements collected by one or more sensors of aerial vehicle 400 and/or control signal provided to one or more components of aerial vehicle 400. Thus, flight control data 610 may represent a behavior of aerial vehicle 400 during retraction and/or lowering of payload 408.

In some implementations, payload mass model 600 may include one or more predetermined equations that define physics-based relationship(s) between one or more values from data 602-610 and payload mass 612. For example, an electrical current value (as represented by tether force data 602) may be multiplied by a torque constant of the motor to determine a torque applied by the motor to spool 404 of the winch system. This torque may be divided by an effective radius of spool 404 about which tether 402 is wound to thereby determine a force applied by the motor to counteract a weight of payload 408. The weight of payload 408 may be divided by the acceleration due to gravity, thereby yielding payload mass 612.

In other implementations, payload mass model 600 may include a regression model. In some cases, the regression model may include a combination of training-based constants and physics-based equations. In some implementations, payload mass model 600 may include a plurality of sub-models configured to calculate various physical quantities involved in determining payload mass 612. Payload mass model 600 and/or the sub-models thereof may include a linear regression model, a multiple linear regression model, and/or a non-linear regression model such as a polynomial regression model.

For example, the regression model may include a friction correction sub-model, which may be expressed as T_{FRICTION}=C₁ω+C₂ω², where T_{FRICTION} represents torque loss due to frictional forces present in the winch system (e.g., while payload 408 is lowered over second distance 418), ω represents the angular velocity of the motor, and C₁ and C₂ represent constants/weights determined, for example, through training of the regression model.

The regression model may also include a current-to-torque sub-model, which may be expressed as T_{SPOOL}=IKₜK_{G}, where T_{SPOOL} represents the torque applied to spool 404, I represents the electrical current value associated with the motor (e.g., the current commanded to the motor, and/or the current actually drawn by the motor) while payload 408 is lowered over second distance 418, Kₜ represents a torque constant of the motor, and K_{G} represent the gear reduction provided by one or more gears present (e.g., in a gearbox and/or gear train) between the motor and spool 404.

The regression model may additionally include a spool radius sub-model, which may be expressed as R_{SPOOL}=C₃θ+C₄, where R_{SPOOL} represents the effective radius of the spool (accounting for the amount of tether present on spool 404), θ represents the angular position of the motor (or, in some cases, spool 404, depending on the location of the position encoder), and C₃ and C₄ represent constants/weights determined, for example, through training of the regression model.

The tension on tether 402 may be expressed by the regression model as F_{TETHER}=(T_{SPOOL}−T_{FRICTION})/R_{SPOOL}, where F_{TETHER} represents the tension experienced by tether 402. The regression model may further include a tension-to-mass sub-model, which may be expressed as M_{PAYLOAD}=C₅F_{TETHER}+C₆I_{UNLOADED}+C₇, where M_{PAYLOAD} represents the calculated mass of payload 408 (i.e., payload mass 612), I_{UNLOADED} represents an electrical current value associated with the motor (e.g., the current commanded to the motor, and/or the current actually drawn by the motor) while empty payload coupling apparatus 412 is lowered down from aerial vehicle 400 prior to pick-up of payload 408, and C₅, C₆, and C₇ represent constants/weights determined, for example, through training of the regression model.

In other cases, the regression model may include a machine learning model, such as an artificial neural network. The machine learning model may be configured through training to determine the relationship between data 602-610 and/or subsets thereof and payload mass 612. Thus, the machine learning model might not include any predetermined physics-based equations, and may instead model the physical relationships between data 602-610 and/or subsets thereof and payload mass 612 using the architecture and/or training-based weights thereof. For example, the machine learning model may be trained using training data that includes a plurality of training samples, each of which includes (i) training input data corresponding to one or more of data 602-610 and (ii) a ground-truth value of a mass of a training payload associated with the training input data. The training data may be obtained by performing the maneuvers described herein in connection with a variety of training payloads of different masses, thus representing how data 602-610 may vary as a function of payload mass.

In some implementations, machine learning model may be configured to process both the initial estimate of the mass of payload 408 (as determined based on data obtained while payload 408 is retracted towards aerial vehicle 400) and the mass of payload 408 as determined based on lowering payload 408 over second distance 418, and thereby determine a combined estimate of the mass of payload 408. The combined estimate of the mass of payload 408 may be more accurate than either mass estimate taken alone because it is based on multiple measurements.

In some implementations, the machine learning model may be configured to process a plurality of samples of each of data 602-610 obtained during the descent of payload 408 over second distance 418 and/or during the initial ascent of payload 408 towards aerial vehicle 400. In some cases, the plurality of samples may represent time periods during which payload 408 moves with a non-zero acceleration, and thus with a velocity different than the substantially constant velocity. The machine learning model may be configured to account for and/or compensate for such periods of non-zero acceleration, and thus accurately determine payload mass 612 notwithstanding any deviations in velocity of payload 408 from the substantially constant velocity. Specifically, the machine learning model may be trained using training data that includes a plurality of training data samples that represent both (i) time periods when a training payload descends with a substantially constant velocity and (ii) time periods when the training payload descends with varying velocity (e.g., due to various external forces causing the payload to accelerate relative to aerial vehicle 400).

### VIII. Additional Example Operations

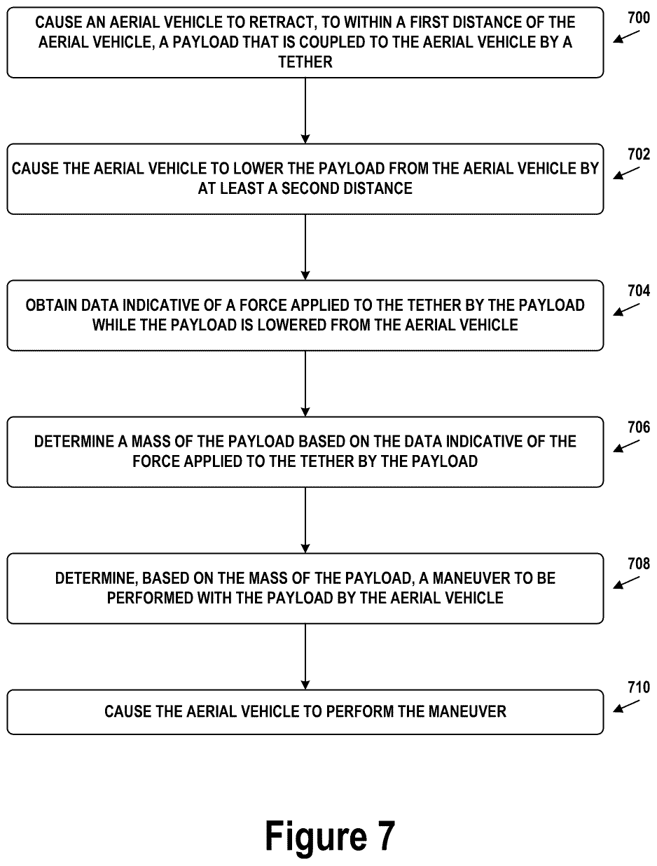

FIG. 7 illustrates a flow chart of operations related to determining a mass of a payload. These operations may be carried out by and/or using aerial vehicle 100, aerial vehicle 200, UAV system 300, aerial vehicle 400, and/or payload mass model 600, among other possibilities. The embodiments of FIG. 7 may be simplified by the removal of any one or more of the features shown therein. Further, these embodiments may be combined with features, aspects, and/or implementations of any of the previous figures or otherwise described herein.

Block 700 may involve causing an aerial vehicle to retract, to within a first distance of the aerial vehicle, a payload that is coupled to the aerial vehicle by a tether.

Block 702 may involve causing the aerial vehicle to lower the payload from the aerial vehicle by at least a second distance.

Block 704 may involve obtaining data indicative of a force applied to the tether by the payload while the payload is lowered from the aerial vehicle.

Block 706 may involve determining a mass of the payload based on the data indicative of the force applied to the tether by the payload.

Block 708 may involve determining, based on the mass of the payload, a maneuver to be performed with the payload by the aerial vehicle.

Block 710 may involve causing the aerial vehicle to perform the maneuver.

In some examples, retracting the payload to within the first distance of the aerial vehicle may place at least a portion of the payload in physical contact with a body of the aerial vehicle.

In some examples, retracting the payload to within the first distance of the aerial vehicle may include retaining the payload in physical contact with the body of the aerial vehicle for at least a threshold time period to suppress oscillation of the payload prior to causing the aerial vehicle to lower the payload.

In some examples, the first distance may be a first threshold distance, which may be predetermined.

In some examples, the second distance may be a second threshold distance, which may be predetermined.

In some examples, initial data may be obtained and may be indicative of an initial force applied to the tether by the payload while the payload is retracted toward the aerial vehicle after the payload is picked up by the aerial vehicle. An initial estimate of the mass of the payload may be determined based on the initial data. Based on the initial estimate of the mass of the payload exceeding an initial mass threshold, the aerial vehicle may be caused to lower the payload from the aerial vehicle by at least the second distance and determine the mass of the payload to validate the initial estimate of the mass of the payload.

In some examples, obtaining the data indicative of the force applied to the tether by the payload may include obtaining an electrical current value associated with operation of a motor in connection with the payload being lowered from the aerial vehicle. The motor may be configured to rotate a spool around which the tether is wound to retract the payload towards the aerial vehicle and lower the payload from the aerial vehicle. Obtaining the data indicative of the force applied to the tether by the payload may also include determining a radius at which the tether is wound around the spool when the payload is lowered from the aerial vehicle by at least the second distance.

In some examples, the data indicative of the force applied to the tether by the payload may include a plurality of data points corresponding to a plurality of time points during the payload being lowered from the aerial vehicle by at least the second distance. Determining the mass of the payload may include determining a filtered value of the plurality of data points, and determining the mass of the payload based on the filtered value of the plurality of data points.

In some examples, determining the mass of the payload may include processing, by a regression model, the data indicative of the force applied to the tether by the payload, and determining the mass of the payload by the regression model. The regression model may be configured to determine masses of payloads based on data indicative of forces applied to tethers of aerial vehicles by the payloads.

In some examples, the regression model may be configured to process and determine the mass of the payload further based on an angular velocity value associated with operation of a motor in connection with the payload being lowered from the aerial vehicle. The motor may be configured to rotate a spool around which the tether is wound.

In some examples, the regression model may be configured to process and determine the mass of the payload further based on a first electrical current value associated with operation of the motor in connection with the payload being lowered from the aerial vehicle.

In some examples, the regression model may be configured to process and determine the mass of the payload further based on an angular position value associated with operation of the motor in connection with the payload being lowered from the aerial vehicle.

In some examples, the regression model may be configured to process and determine the mass of the payload further based on a second current value associated with operation of the motor in connection with the tether being deployed from the aerial vehicle prior to pick-up of the payload.

In some examples, the regression model may be configured to process and determine the mass of the payload further based on an environmental condition value that represents an environmental condition (e.g., wind, temperature, pressure, etc.) present in an environment of the aerial vehicle.

In some examples, the regression model may include a machine learning model.

In some examples, determining the maneuver to be performed with the payload may include, based on the mass of the payload being greater than a threshold mass, rejecting the payload and determining to drop off the payload by the aerial vehicle at a pick-up location of the payload.

In some examples, determining the maneuver to be performed with the payload may include, based on the mass of the payload being less than the threshold mass, accepting the payload and determining to transport the payload by the aerial vehicle to a destination location assigned to the payload.

In some examples, causing the aerial vehicle to lower the payload from the aerial vehicle by at least the second distance may include causing the aerial vehicle to lower the payload from the aerial vehicle with a substantially constant velocity.

In some examples, the aerial vehicle may be caused to attempt to hover in a fixed position in space while the payload is lowered from the aerial vehicle by at least the second distance.

In some examples, after determining the maneuver, the aerial vehicle may be caused to retract the payload towards the aerial vehicle before causing the aerial vehicle to perform the maneuver.

In some examples, a speed with which the payload is lowered from the aerial vehicle may be lower than a speed with which the payload is retracted towards the aerial vehicle.

### IX. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
causing an aerial vehicle to retract, to within a first distance of the aerial vehicle, a payload that is coupled to the aerial vehicle by a tether;
causing the aerial vehicle to lower the payload from the aerial vehicle by at least a second distance;
obtaining data indicative of a force applied to the tether by the payload while the payload is lowered from the aerial vehicle;
determining a mass of the payload based on the data indicative of the force applied to the tether by the payload;
determining, based on the mass of the payload, a maneuver to be performed with the payload by the aerial vehicle; and
causing the aerial vehicle to perform the maneuver.

2. The method of claim 1, wherein retracting the payload to within the first distance of the aerial vehicle places at least a portion of the payload in physical contact with a body of the aerial vehicle.

3. The method of claim 2, wherein retracting the payload to within the first distance of the aerial vehicle comprises:
retaining the payload in physical contact with the body of the aerial vehicle for at least a threshold time period to suppress oscillation of the payload prior to causing the aerial vehicle to lower the payload.

4. The method of claim 1, further comprising:
obtaining initial data indicative of an initial force applied to the tether by the payload while the payload is retracted toward the aerial vehicle after the payload is picked up by the aerial vehicle;
determining an initial estimate of the mass of the payload based on the initial data; and
based on the initial estimate of the mass of the payload exceeding an initial mass threshold, causing the aerial vehicle to lower the payload from the aerial vehicle by at least the second distance and determine the mass of the payload to validate the initial estimate of the mass of the payload.

5. The method of claim 1, wherein obtaining the data indicative of the force applied to the tether by the payload comprises:
obtaining an electrical current value associated with operation of a motor in connection with the payload being lowered from the aerial vehicle, wherein the motor is configured to rotate a spool around which the tether is wound to retract the payload towards the aerial vehicle and lower the payload from the aerial vehicle; and
determining a radius at which the tether is wound around the spool when the payload is lowered from the aerial vehicle by at least the second distance.

6. The method of claim 1, wherein the data indicative of the force applied to the tether by the payload comprises a plurality of data points corresponding to a plurality of time points during the payload being lowered from the aerial vehicle by at least the second distance, and wherein determining the mass of the payload comprises:
determining a filtered value of the plurality of data points; and
determining the mass of the payload based on the filtered value of the plurality of data points.

7. The method of claim 1, wherein determining the mass of the payload comprises:
processing, by a regression model, the data indicative of the force applied to the tether by the payload, wherein the regression model is configured to determine masses of payloads based on data indicative of forces applied to tethers of aerial vehicles by the payloads; and
determining the mass of the payload by the regression model.

8. The method of claim 7, wherein the regression model is configured to process and determine the mass of the payload further based on one or more of:
an angular velocity value associated with operation of a motor in connection with the payload being lowered from the aerial vehicle, wherein the motor is configured to rotate a spool around which the tether is wound;
a first electrical current value associated with operation of the motor in connection with the payload being lowered from the aerial vehicle;
an angular position value associated with operation of the motor in connection with the payload being lowered from the aerial vehicle;
a second current value associated with operation of the motor in connection with the tether being deployed from the aerial vehicle prior to pick-up of the payload; or
an environmental condition value that represents an environmental condition present in an environment of the aerial vehicle.

9. The method of claim 7, wherein the regression model comprises a machine learning model.

10. The method of claim 1, wherein determining the maneuver to be performed with the payload comprises one or more of:
based on the mass of the payload being greater than a threshold mass, rejecting the payload and determining to drop off the payload by the aerial vehicle at a pick-up location of the payload; or
based on the mass of the payload being less than the threshold mass, accepting the payload and determining to transport the payload by the aerial vehicle to a destination location assigned to the payload.

11. The method of claim 1, wherein causing the aerial vehicle to lower the payload from the aerial vehicle by at least the second distance comprises:
causing the aerial vehicle to lower the payload from the aerial vehicle with a substantially constant velocity.

12. The method of claim 1, further comprising:
causing the aerial vehicle to attempt to hover in a fixed position in space while the payload is lowered from the aerial vehicle by at least the second distance.

13. The method of claim 1, further comprising:
after determining the maneuver, causing the aerial vehicle to retract the payload towards the aerial vehicle before causing the aerial vehicle to perform the maneuver.

14. The method of claim 1, wherein a speed with which the payload is lowered from the aerial vehicle is lower than a speed with which the payload is retracted towards the aerial vehicle.

15. A system comprising a processor configured to perform operations comprising:
causing an aerial vehicle to retract, to within a first distance of the aerial vehicle, a payload that is coupled to the aerial vehicle by a tether;
causing the aerial vehicle to lower the payload from the aerial vehicle by at least a second distance;
obtaining data indicative of a force applied to the tether by the payload while the payload is lowered from the aerial vehicle;
determining a mass of the payload based on the data indicative of the force applied to the tether by the payload;
determining, based on the mass of the payload, a maneuver to be performed with the payload by the aerial vehicle; and
causing the aerial vehicle to perform the maneuver.

16. The system of claim 15, wherein retracting the payload to within the first distance of the aerial vehicle places at least a portion of the payload in physical contact with a body of the aerial vehicle.

17. The system of claim 15, wherein the operations further comprise:
obtaining initial data indicative of an initial force applied to the tether by the payload while the payload is retracted toward the aerial vehicle after the payload is picked up by the aerial vehicle;
determining an initial estimate of the mass of the payload based on the initial data; and
based on the initial estimate of the mass of the payload exceeding an initial mass threshold, causing the aerial vehicle to lower the payload from the aerial vehicle by at least the second distance and determine the mass of the payload to validate the initial estimate of the mass of the payload.

18. The system of claim 15, wherein determining the mass of the payload comprises:
processing, by a regression model, the data indicative of the force applied to the tether by the payload, wherein the regression model is configured to determine masses of payloads based on data indicative of forces applied to tethers of aerial vehicles by the payloads; and
determining the mass of the payload by the regression model.

19. The system of claim 15, wherein causing the aerial vehicle to lower the payload from the aerial vehicle by at least the second distance comprises:
causing the aerial vehicle to lower the payload from the aerial vehicle with a substantially constant velocity.

20. A non-transitory computer-readable medium having stored thereon instructions that, when executed by a computing device, cause the computing device to perform operations comprising:
causing an aerial vehicle to retract, to within a first distance of the aerial vehicle, a payload that is coupled to the aerial vehicle by a tether;
causing the aerial vehicle to lower the payload from the aerial vehicle by at least a second distance;
obtaining data indicative of a force applied to the tether by the payload while the payload is lowered from the aerial vehicle;
determining a mass of the payload based on the data indicative of the force applied to the tether by the payload;
determining, based on the mass of the payload, a maneuver to be performed with the payload by the aerial vehicle; and
causing the aerial vehicle to perform the maneuver.
